(19) United States
(12) Patent Application Publication
(10) Pub. No.: US 2005/0176913 A1
(43) Pub. Date: Aug. 11, 2005

(54) Lignocellulosic composites, adhesive systems, and process

(76) Inventors: Herbert R. Gillis, Laughlin, NV (US); Anthony A. Parker, Newtown, PA (US); Paula Y. Teachey, Burlington Township, NJ (US); Joseph J. Marcinko, Mullica Hill, NJ (US)

Correspondence Address: Patent Counsel;Huntsman Polyurethanes, 286 Mantua Grove Road, West Deptford, NJ, 08066-1732, US

(21) Appl. No.: 10/976,233

(22) Filed: Oct. 28, 2004

Related U.S. Application Data
(63) Continuation of application No. PCT/US03/13931, filed on May 2, 2003.
(60) Provisional application No. 60/377,961, filed on May 3, 2002.

(51) Int. Cl. C08G 18/00

(52) U.S. Cl. 528/44

(57) ABSTRACT

Polyisocyanate-based adhesive systems for the preparation of adhesive bonded lignocellulosic articles that meet all the requirements of ASTM D-2559-00 Section 14 and/or ASTM D-2559-00 Sections 14 and 15. Further provided is a process for using the adhesive system and lignocellulosic composite articles produced thereby.

### CROSS REFERENCE TO RELATED APPLICATIONS

This application claims priority to U.S. Provisional Application Ser. No. 60/377,961, which was filed on May 3, 2002. This application is also a continuation of international application number PCT/US03/13931, filed May 2, 2003.

### TECHNICAL FIELD

The present invention is directed towards lignocellulosic composites, adhesive systems and process for making them, and structures produced therefrom.

### BACKGROUND OF THE INVENTION

It is known in the art that lignocellulosic composites may be prepared using polyisocyanate-based adhesives. Polyisocyanate-based adhesives have a number of technical advantages over other types of adhesives used in the art. One advantage is that polyisocyanate-based adhesives are able to cure and form a satisfactory adhesive bond without the application of external heat. This is known in the art as “cold curing”. Cold curing is often used in the manufacture of engineered lumber composites, such as I-beams and laminated veneer lumber (“LVL”), because such engineered lumber composites are often quite thick and the application of external heat is often difficult or impossible because the rate of heat transfer is often too slow for an economically practical curing process. Another advantage is that polyisocyanate-based adhesives work effectively on relatively moist lignocellulosic substrates, even “green” wood; whereas, many other kinds of wood adhesives do not. This feature of polyisocyanate-based adhesives reduces or eliminates the need for pre-drying of the substrate. Yet another advantage of polyisocyanate-based adhesives is the quality of the adhesive bond itself. Lignocellulosic composites prepared using polyisocyanates generally have improved resistance to moisture attack, and provide higher bond strength per unit weight of adhesive applied onto the surface of the substrate. Despite the technical advantages of polyisocyanate-based adhesives, the industry often perceives polyisocyanate-based adhesives as being more expensive than other types of wood adhesives, such as phenolics (phenol formaldehyde resins) and aminoplasts, especially urea-formaldehyde resins. It is also true that many of the isocyanate-based adhesives of the prior art have great difficulty passing key building code specifications, such as the requirements for resistance to shear compression loading and resistance to de-lamination during accelerated exposure, according to the procedures described in ASTM Specification D-2559-00, Sections 14 and 15, respectively. The requirements of this ASTM procedure are particularly demanding for polyisocyanate-based wood adhesives in engineered lumber applications.

It is also known in the prior art to use primers and adhesion promoters to enhance the performance of an adhesive. Such techniques are rarely used in the manufacture of composite lignocellulosic articles because of the cost of the primer and the added complexity of the process. Many adhesion promoters that are widely used in the production of non-lignocellulosic composites are relatively less effective when used on lignocellulosic substrates. Organo functional silanes are, for example, relatively ineffective as adhesion promoters on some kinds of wood surfaces in conjunction with polyisocyanate adhesives. The well-known organosilane adhesion promoters are also rather expensive and are difficult to handle because they are moisture sensitive. Some adhesion promoting effects can be obtained with amino functional silane adhesion promoters by pre-hydrolysis of the silane, but this does not solve the problem of the high cost of these silicon-based adhesion promoters. The pre-hydrolyzed silanes also may have a limited shelf life.

Polymeric primers are also known in the art, and have been disclosed for the priming of wood surfaces (see e.g. U.S. Pat. Nos. 5,888,655, 4,397,707, and 5,543,487; “Wood Adhesives 1995”, Proceedings of Symposium Sponsored by the USDA, Proceedings No. 7296, pages 47-55; Forest Products Journal, vol. 50, No. 10, October-2000, pages 69-75).

The prior art also contains reference to the use of a moisture curing urethane resin as a surface primer and the use of polyurethane polymer dispersions as surface primers for promoting adhesion (see e.g. U.S. Pat. Nos. 6,075,002 and 6,299,974). However, many such polymeric resins have disadvantages that render them less than totally satisfactory. For example, most polymeric resin primers must be prepared in advance, which adds cost. Additionally, many primers need to be cured on the substrate, which also adds cost and complexity to the overall bonding process. Further, certain primers release hazardous emissions such as formaldehyde. As an example of the difficulties involved in using polymeric surface treatments known in the art, hydroxymethylated resorcinol (“HMR”) must be used within hours of its preparation (typically 3 to 8 hours) in order to be most effective. This fact imposes serious practical limitations, in as much as the HMR resin must be prepared near the point of use and cannot be stored or transported.

Thus, there is a need in the industry for improved isocyanate-based adhesive systems suitable for making high quality bonded lignocellulosic composites that pass all the relevant requirements of ASTM D-2559-00 Section 14 and/or ASTM D-2559-00 Sections 14 and 15. The improved adhesive systems should desirably be simpler to use, more cost effective, and safer to work with than the polyisocyanate-based wood adhesives currently known in the art for engineered lumber applications. The improved isocyanate-based adhesive systems should also be of sufficient shelf stability to permit storage and transportation, and should be free of formaldehyde emissions.

### SUMMARY OF THE INVENTION

The invention provides a polyisocyanate based wood adhesive system that is suitable for preparing lignocellulosic composites that meet all the requirements of ASTM D-2559-00 Section 14 and/or ASTM D-2559-00 Sections 14 and 15, in the absence of any other types of adhesives, wherein the polyisocyanate based wood adhesive system comprises:
1) an organic polyisocyanate composition containing free organically bound isocyanate groups; and
2) an optional surface treatment.
   Preferably, all the constituents of the optional surface treatment, when used, are storage stable and usable for greater than 24 hours at 25° C. at 1 standard atmosphere pressure (760 mmHg), and that no pre-mixing or pre-reaction of the surface treatment is required within 24 hours of the application thereof to the lignocellulosic substrate to achieve the successful production of said adhesive bonded lignocellulosic composite.

The invention further provides a process for preparing a bonded article from lignocellulosic substrates preferably using a single adhesive system, the process comprising the steps of:
A) providing at least two lignocellulosic surfaces for bonding;
B) providing, as the single adhesive system, a polyisocyanate based wood adhesive system comprising:
   1) an organic polyisocyanate composition containing free organically bound isocyanate groups; and
   2) an optional surface treatment;
C) applying the polyisocyanate based wood adhesive system to at least a portion of at least one of the lignocellulosic surfaces for bonding;
D) contacting the lignocellulosic surfaces under conditions suitable for forming an adhesive bond between the lignocellulosic surfaces; and
E) recovering from Step-D an adhesive bonded lignocellulosic article that satisfies all the requirements of Section 14 of ASTM D-2559-00 and/or Sections 14 and 15 of ASTM D-2559-00.
   Preferably, all constituents of the optional surface treatment provided in Step B are storage stable and usable for greater than 24 hours at 25° C. at 1 standard atmosphere pressure (760 mmHg), and that no pre-mixing or pre-reaction of the surface treatment is required within 24 hours of the application thereof to the lignocellulosic substrate in order to successfully produce the adhesive bonded lignocellulosic composite article recovered in Step E.

In more preferred embodiments, all the constituents of the adhesive system are storage stable and usable for greater than 24 hours at 25° C. at 1 standard atmosphere of pressure (760 mmHg), and no pre-mixing or pre-reaction of the adhesive system, or any of the components of the adhesive system, is required within 24 hours of the application thereof to the lignocellulosic substrate to achieve the successful production of said bonded lignocellulosic composite. In these more preferred embodiments, the organic polyisocyanate composition consists of a single component, most preferably comprising at least one isocyanate terminated prepolymer species.

In still more preferred embodiments, the constituents of the adhesive system are all storage stable and usable for greater than 7 days at 25° C. at 1 standard atmosphere pressure (760 mmHg) and no pre-mixing or pre-reaction of the adhesive system, or any of the components of the adhesive system, is required within 7 days of the application thereof to the lignocellulosic substrate in order to successfully produce an adhesive bonded lignocellulosic article that satisfies all the requirements of ASTM D-2559-00 Section 14 and/or ASTM D-2559-00 Sections 14 and 15.

In another preferred embodiment, all the constituents of the adhesive system are liquids at 25° C. at 1 standard atmosphere pressure (760 mmHg). In yet another preferred embodiment, no agitation of any of the constituents of the adhesive system is required for a period of greater than 24 hours, more preferably greater than 7 days, storage at 25° C. at 1 standard atmosphere pressure (760 mmHg), prior to use.

In a particularly preferred embodiment, at least one of the lignocellulosic surfaces for bonding are selected from the group consisting of southern yellow pine (SYP) and Douglass fir (DF).

In yet another highly preferred embodiment, the organic polyisocyanate composition further comprises as a dispersed phase an organic crystalline or semicrystalline polymeric material. In some highly preferred aspects of this embodiment, the crystalline or semicrystalline phase is derived from a polycaprolactone diol with a molecular weight (number averaged) greater than 30,000. In the most highly preferred aspects of this embodiment, the organic polyisocyanate composition containing the crystalline or semicrystalline organic dispersed phase is in the form of a paste or a spreadable gel at 25° C., and is preferably applied at least in part to at least one of the substrates to be bonded in the form of a paste or a spreadable gel.

In another especially preferred embodiment, the curing of the adhesive system (Step-D) can be accomplished without the application of heat or of indirect sources of heat such as radiation. The adhesive system, in this especially preferred embodiment, is capable of curing at ambient temperatures (typically about 25° C.). Pressure is desirably used to facilitate bonding in this “cold cure” mode. The use of pressure, usually in the form of a press, is desirable in other embodiments of the invention as well, regardless of whether external heating is applied.

### BRIEF DESCRIPTION OF THE FIGURES

FIG. 1 shows relative cure time as a function of urea surface treatment.

FIG. 2 is a cutting diagram.

### DETAILED DESCRIPTION OF THE INVENTION

The isocyanate-based adhesive systems disclosed herein are uniquely suited for the production of adhesive bonded lignocellulosic articles, preferably structural laminated wood products, that satisfy all the requirements of ASTM D-2559-00 Section 14 and/or ASTM D-2559-00 Sections 14 and 15. The adhesive laminated wood articles are preferred for exterior (wet use) exposure conditions. The content of the specification and requirements of ASTM D-2559-00 is herein incorporated fully by reference. The adhesive system combines the known advantages of isocyanate adhesives with the capability of passing the requirements of ASTM D-2559-00 Section 14 and/or ASTM D-2559-00 Sections 14 and 15, without the need of using any adhesives (co-adhesives) other than the inventive adhesive system itself. The adhesive systems optionally include the use of certain surface treatments. The adhesive systems are further characterized by having improved storage stability and do not require any pre-mixing or pre-reaction of any ingredients of the surface treatment within 24 hours, preferably 7 days or more, prior to the application thereof to the lignocellulosic substrate for bonding. The application of the individual constituents of the adhesive system to the substrate may be performed in any desired manner, including, but not limited to, rolling, doctor blading, spraying, brushing, wiping, ribbon coating, combinations of these methods, and the like. When an optional surface treatment is used as a constituent of the adhesive system, the surface treatment my be applied prior to the organic polyisocyanate adhesive, or to the surface of the uncured polyisocyanate adhesive after the latter has been applied. Alternatively, the polyisocyanate adhesive and the optional surface treatment may be applied onto the opposing surfaces of an adhesive bond. The polyisocyanate constituent and the surface treatment constituent may be applied by the same or different methods of application. Premixing or pre-reaction of the polyisocyanate adhesive and the optional surface treatment separately from the substrate, followed by subsequent application of the premixture or pre-reaction product to the substrate, is much less desirable and should generally be avoided.

The adhesive systems and the process disclosed herein offer significant logistical and economic improvements by providing for storage stability and transportability of components. It is not necessary to prepare any components of the adhesive system in situ and use it immediately (i.e. within 24 hours of preparation) due to very short shelf stability. It is not necessary to “time” the application of the surface treatment to fit a peak performance “window” that last only a few hours (i.e. less than 24 hours).

The more preferred organic polyisocyanates and optional surface treatment compositions are storage stable for weeks or months under ambient conditions if protected from moisture, and provided they do not contain any free formaldehyde or any species that liberate formaldehyde under the conditions likely to be encountered during the storage or use of the adhesive system. Accordingly, the adhesive systems and process disclosed herein provide for the production of adhesive bonded lignocellulosic laminated articles that satisfy all the requirements of ASTM D-2559-00 Section 14 and/or ASTM D-2559-00 Sections 14 and 15, while additionally providing for improved ease of handling and improved safety.

In a particularly preferred embodiment, the adhesive system comprises just a single organic polyisocyanate composition (a “one component” isocyanate adhesive) and the optional surface treatment. The optional surface treatment is a single component composition as well, and does not require any pre-reaction of precursor ingredients or pre-mixing of ingredients within 24 hours, preferably 7 days, prior to its application to the wood substrate. However, it is within the scope of the invention, although less convenient in practice, to use more than one different type of optional surface treatment provided that these do not require mixing or reaction within 24 hours of application to the substrate in order to produce a successful adhesive bond (as defined hereinabove). In this particularly preferred embodiment, the single organic polyisocyanate composition is the sole adhesive used. The optional surface treatments have no significant adhesive effect by themselves, at the usage levels required for the successful practice of the invention. These optional surface treatments, however, have an unexpected and surprising synergistic effect when used with the polyisocyanate composition. It is within the scope of the invention, and, of this particularly preferred embodiment, to use other optional additives, such as fire retardants, which are known in the art, are not adhesives in themselves at the levels required for their effective use, and are not effective as adhesion promoters for the organic polyisocyanate at the levels required for their effective use. These other optional additives, when used, may be applied directly to the substrate, or applied in combination with any or all of the constituents of the inventive adhesive system, or any combination thereof. The other optional additives, when used, may be applied by any know means that do not adversely effect the performance or stability, as defined above, of the adhesive system.

In another particularly preferred embodiment, the adhesive system consists essentially of just a single organic polyisocyanate composition (a “one component” isocyanate adhesive), and no adhesion promoter is required for a successful adhesive bond (as defined above). In this embodiment, it is also acceptable to use optional additives that are not adhesives or adhesion promoters at the levels required for their effective use. These other optional additives, when used, may be applied by any know means which do not adversely effect the performance or stability, as defined above, of the organic polyisocyanate adhesive.

Any substrate that will form a bond to a lignocellulosic substrate through the intermediacy of a polyisocyanate adhesive can be used with the adhesive systems disclosed herein. Preferably, at least two of the substrates to be bonded are lignocellulosic materials, and more preferably, all of the substrates to be bonded are lignocellulosic materials. Non-limiting examples of optional non-lignocellulosic substrates may include, without limitation, cloth, paper, cardboard, concrete, glass, plastic, metal, combinations of these, and the like. The term “lignocellulosic material” is intended to mean a woody material, including, without limitation, wooden boards, wood veneers, wood fibers, wood strips, wood flakes, wood particles, comminuted agricultural wastes (i.e. rice hulls, baggasse, straw, and the like), other wood based composites, combinations of these, and the like. Preferred lignocellulosic substrates include whole boards, wood strips, and/or wood veneers, especially boards or veneers of a definite pre-determine shape that have been cut or shaped in advance for the purposes of being fitted together in a definite and pre-determined relative geometric relationship in the final composite structure. The preferred lignocellulosic composites are laminates containing at least two wood boards, wood veneers, or wood strips that have been laminated together. The preferred laminates are in accordance with the specifications of ASTM D-2559-00, as are the methods of adhesive testing and the requirements for successful adhesive performance. Lignocellulosic substrates with a well-defined and consistent geometry are most preferred for use in preparing lignocellulosic laminates according to the process of the invention. Substrates with a less defined geometry, such as chipboards, fiberboards, particleboards, and the like may, however, also optionally be used in preparing lignocellulosic composites employing the adhesive systems disclosed herein. Non-limiting examples of the types of composites best suited to the process disclosed herein include, without limitation, lignocellulosic substrates having a relatively well-defined geometry, such as laminated veneer lumber (LVL), plywood, composite beams (such as I-beams, also known as I-Joists), and laminated strand lumber.

The adhesives disclosed herein may also be used to prepare composites that comprise lignocellulosic substrates that are themselves composites. For example, laminated beams and I-joists may be prepared using adhesive systems disclosed herein from substrates that include, without limitation, boards or strips made of OSB, particleboard, fiberboard, and combinations thereof.

Any wood species that is known in the art to be capable of being bonded with the aid of polyisocyanate-based adhesive systems may be used with the adhesive systems disclosed herein. Particularly preferred wood species for use in the process disclosed herein include southern yellow pine (SYP) and Douglass fir (DF). Combinations of these two species may optionally be used in preparing a given composite article, but it is generally more preferred to use one species alone in the production of any given lignocellulosic composite article. It is, of course, also possible to use combinations of one or more of these preferred species in combination with other wood species.

The polyisocyanate-based adhesive systems disclosed herein contain an organic polyisocyanate composition containing free organically bound isocyanate groups. Polyisocyanate compositions suitable for use as the polyisocyanate adhesive constituent within the polyisocyanate-based adhesive systems may include any of the known organic polyisocyanate products, including base (monomeric) polyisocyanates, isocyanate group terminated prepolymers, or combinations of these. The polyisocyanates have free organically bound isocyanate (—NCO) groups. The term “polyisocyanate” in the context of the present invention is understood to encompass difunctional isocyanate species, higher functionality isocyanate species, and mixtures thereof. The term “base” polyisocyanate (or monomeric polyisocyanate) will be understood to refer to polyisocyanates which have not been modified by reaction with isocyanate reactive species to form prepolymers. This term does, however, encompass polyisocyanates that have been modified by various known self-condensation reactions of polyisocyanates, such as carbodiimide modification, uretonimine modification, and trimer (isocyanurate) modification, under the proviso that the modified polyisocyanate still contains free isocyanate groups available for further reaction.

Additionally, a majority of the isocyanate groups of the polyisocyanate adhesive are preferably bonded directly to aromatic rings. Further, the polyisocyanate adhesive may contain tertiary amine groups. Also, the polyisocyanate adhesive may optionally include an inert filler and an inert, substantially non-volatile, oil. In a highly preferred embodiment, the polyisocyanate adhesive contains a dispersed organic reinforcing filler that is at least semi-crystalline. This dispersed filler may optionally contain groups that are reactive towards isocyanate groups, and optionally forming dispersed isocyanate terminated prepolymer species.

Base polyisocyanates useful in the present invention are those having a number-average isocyanate functionality of about 2.0 or greater, preferably greater than 2.1, more preferably greater than 2.3, and most preferably greater than 2.4. The base polyisocyanates should have a number average molecular weight of from about 100 to about 5000, preferably about 120 to about 1800, more preferably 150 to 1000, still more preferably 170 to 700, even more preferably 180 to 500, and most preferably 200 to 400. Preferably, at least 80 mole percent and more preferably greater than 95 mole percent of the isocyanate groups of the base polyisocyanate composition are bonded directly to aromatic rings. Examples of suitable base polyisocyanates include aromatic polyisocyanates such as p-phenylene diisocyanate, m-phenylene diisocyanate, 2,4-toluene diisocyanate, 2,6-toluene diisocyanate, naphthalene diisocyanates, dianisidine diisocyanate, polymethylene polyphenyl polyisocyanates, 2,4′-diphenylmethane diisocyanate (2,4′-MDI), 4,4′-diphenylmethane diisocyanate (4,4′-MDI), 2,2′-diphenylmethane diisocyanate (2,2′-MDI), 3,3′-dimethyl-4,4′-biphenylenediisocyanate, mixtures of these, and the like. Polymethylene polyphenyl polyisocyanates (MDI series polyisocyanates) having number averaged functionalities of greater than 2 are an especially preferred family of aromatic polyisocyanates. MDI base polyisocyanates should preferably have a combined 2,4′-MDI and 2,2′-MDI content of less than 18.0%, more preferably less than 10% and most preferably less than 5%. However, any MDI diisocyanate isomer composition is suitable for use. MDI diisocyanate isomers, mixtures of these isomers with tri and higher functionality polymethylene polyphenyl polyisocyanates, the tri or higher functionality polymethylene polyphenyl polyisocyanates themselves, and non-prepolymer derivatives of MDI series polyisocyanates (such as the carbodiimide, uretonimine, and/or isocyanurate modified derivatives) may also be used.

The base polyisocyanates may optionally include minor amounts of aliphatic polyisocyanates. Suitable aliphatic polyisocyanates include isophorone diisocyanate, 1,6-hexamethylene diisocyanate, 1,4-cyclohexyl diisocyanate, saturated analogues of the above-mentioned aromatic polyisocyanates, isocyanate functional non-prepolymer derivatives of these, and mixtures thereof.

The base polyisocyanates preferably comprise a polymeric polyisocyanate, and more preferably polymeric diphenylmethane diisocyanate (polymethylene polyphenyl polyisocyanate) species of functionality 3 or greater. Commercially available polymeric polyisocyanates of the MDI series include RUBINATE® M polyisocyanate (commercially available from Huntsman International LLC with a number averaged isocyanate group functionality of about 2.7). This isocyanate product is a complex mixture of MDI series diisocyanates and higher functionality MDI series polyisocyanates. The MDI series diisocyanates present in this product are predominantly 4,4′-MDI, with lesser amounts of 2,4′-MDI and traces of 2,2′-MDI. Polymeric MDI products, such as RUBINATE® M polyisocyanate, may be further diluted with MDI series diisocyanates if desired. Some dilution is preferred when the polymeric MDI is employed as the base polyisocyanate for preparing a quasiprepolymer.

A particularly preferred category of polyisocyanates includes quasiprepolymers of MDI series base polyisocyanates. The term quasiprepolymer is understood to mean that the polyisocyanate comprises both isocyanate group terminated reaction products of one or more isocyanate-reactive materials, such as polyols, and some residual (unreacted) monomeric polyisocyanate (base polyisocyanate). A particularly preferred subclass of quasiprepolymers of MDI series base polyisocyanates for use in the invention include quasiprepolymers formed from the reaction of the MDI series base polyisocyanate composition with an aliphatic amine initiated polyol. The most preferred aliphatic amine initiated polyols for this purpose are aliphatic amine initiated polyether polyols formed from the addition of both propylene oxide and ethylene oxide to an aliphatic amine initiator and/or to ammonia.

Polyols are suitable for preparing the isocyanate terminated prepolymers. The polyols preferably contain at least one aliphatic tertiary amine-initiated polyol having a content of ethylene oxide (oxyethylene) units of at least 1% by weight. Other types of polyols may optionally be used in combination with the said aliphatic tertiary amine polyol. The preferred aliphatic tertiary amine polyol for use in preparing the preferred quasiprepolymer polyisocyanate is at least one hydroxy functional compound having two or more organic —OH groups and at least one aliphatic tertiary amine-initiator group wherein said aliphatic amine-initiated polyol compound is characterized by having an ethylene oxide content of at least 1% by weight of the molecule. Mixtures of more than one such tertiary amine containing polyol compound may of course, be used if desired. Preferably, the ethylene oxide content of the tertiary amine polyol is from about 1 to about 90%, more preferably about 5 to about 60% and most preferably about 10 to about 40% by weight of the molecule. The aliphatic tertiary amine-initiated polyol desirably provides an ethylene oxide content in the said quasiprepolymer of about 0.01 to about 27% by weight, preferably about 0.35 to about 12% and most preferably about 1 to about 8% by weight of the total quasiprepolymer. It has been found that the preferred amine initiated polyol may contain any amount of propylene oxide, which is consistent with these limits on the ethylene oxide content thereof. Preferred aliphatic tertiary amine-initiated polyols include the known alkoxylation products of aliphatic amines or aminoalcohols having at least two active hydrogen atoms with ethylene oxide and propylene oxide.

Suitable initiator molecules include: ammonia, ethylene diamine, hexamethylene diamine, methyl amine, isopropanolamine, diisopropanolamine, ethanolamine, diethanolamine, N-methyl diethanolamine, tetrahydroxyethyl ethylenediamine, mixtures of these initiators, and the like. The most suitable aliphatic tertiary amine-initiated polyols are those wherein the initiator comprises about 1 to about 18 and preferably about 1 to about 6 carbon atoms. Preferred aliphatic tertiary amine-initiated polyols are those which have a number averaged molecular weight of about 1000 to about 10,000 and more preferably 1500 to about 6000 and a number average OH functionality of about 1.8 to about 6.0, more preferably 2.0 to 6.0.

It has been found that the concentration of tertiary aliphatically bound amine nitrogen in the amine-initiated polyol is related to the effectiveness (i.e. desired fast cure rate) of the final adhesive composition. In general, it is preferred that the tertiary aliphatically bound amine nitrogen concentration in the final quasiprepolymer composition, due to the aliphatic amine-initiated polyol(s), should be about 0.002 to about 0.05 eqN/100 g, more preferably about 0.005 to about 0.025 eqN/100 g, still more preferably about 0.01 to about 0.02 eqN/100 g, and most preferably about 0.012 to about 0.016 eqN/100 g. The term “eqN” in the previous sentence refers to the number of equivalents of tertiary aliphatic nitrogen contributed by the aliphatic amine initiated polyol(s), and the weight (100 g) is that of the final quasiprepolymer composition. Preferred amine-initiated aliphatic polyether polyols for use in the preferred quasiprepolymers include those prepared from ethylene diamine, triethylene tetramine and/or triethanolamine, as the initiators. The more preferred quasiprepolymer compositions are derived from the aliphatic tertiary amine-initiated polyol component, in an amount of about 1 to about 30%, preferably about 7 to about 20% and most preferably about 10 to about 20% by weight based upon the total amount of the formulation of the said quasiprepolymer composition. In its most preferred form, the amine-initiated polyol is an ethylene diamine-initiated polyol containing ethylene oxide. Suitable ethylene diamine-initiated polyols are those having an ethylene oxide content of about 1 to about 90% by weight, preferably about 5 to about 60%, and most preferably about 10 to about 40% by weight of the polyol. The ethylene oxide content refers to the amount of ethylene oxide utilized in the preparation of the amine initiated polyols as discussed above.

During production of the preferred amine initiated polyols, the ethylene oxide reacts with the initiator. The polyols should most preferably have a molecular weight in the range of 1500 to 5000. The most preferred amine initiated polyols are free of primary or secondary amine groups. Non-limiting examples of suitable ethylene diamine-initiated polyols useful in preparing the preferred quasiprepolymer compositions include those of the following general formula:
(H[EO]_{y}[PO]ₓ)₂N—CH₂CH₂—N([PO]ₓ[EO]_{y}H)₂
wherein x denotes the number of PO units in each polyether chain and has a value of from about 1.0 to about 29.0 on a number averaged basis, preferably about 4.0 to about 20 and most preferably about 4.0 to about 14 on a number averaged basis; and y denotes the number of EO units in each polyether chain and has a value of from about 1.0 to about 10.0 on a number averaged basis and preferably about 2.0 to about 4.0 on a number averaged basis. The expression “EO” denotes a single oxyethyene unit in the polyether chain. The expression “PO” denotes a single oxypropylene unit in the polyether chain. The expression “N” is a nitrogen atom from the ethylene diamine initiator.

Among the preferred ethylene diamine-initiated polyols available commercially are those such as the SYNPERONIC® brand polyols available from ICI Americas, Inc. A particularly preferred example of this commercial series of polyols is SYNPERONIC® T/304 polyol.

Although not wishing to be limited to a single theory, it is believed that the amine-initiated polyol reaction product remains inactive in the quaiprepolymer based adhesive composition until it comes into contact with the moisture in or on the substrate (i.e. wood). Once the amine initiated polyol reaction product contacts the moisture, it is believed to promote the reaction between the —NCO groups of the polyisocyanate adhesive and water in the system, thus accelerating cure and adhesion. The result is that the more preferred polyisocyanate adhesives are relatively fast curing, and are especially well suited for cold-curing applications. Moreover, the adhesive remains on the surface of the substrate where it is most effective and can develop the cold tack most desirable for processing.

Other polyols may optionally be used in combination with the preferred amine-initiated polyol (described above) in the isocyanate reactive component used for forming the said preferred quasiprepolymer based adhesive systems for use in the invention. It is generally more preferred to include a non-amine containing polyol, in addition to the amine-initiated polyol, in forming the quasiprepolymer. It is desirable, however, that the ethylene oxide containing aliphatic amine-initiated polyether polyol comprise at least 10% by weight of the total isocyanate reactive component used in making the quasiprepolymer. It is more desirable that the ethylene oxide containing aliphatic amine-initiated polyether polyol comprise at least 25% by weight, still more desirably at least 30% by weight, even more desirably at least 40% by weight, and most desirably about 50% by weight of the total isocyanate reactive component used in making the quasiprepolymer. Examples of preferred kinds of optional additional non-amine polyols suitable for use in forming quasiprepolymers include: (a) polyether polyols, thioether polyols, and/or hydrocarbon-based polyols having a number averaged molecular weight of from about 1000 to 3000 and a number average hydroxyl functionality of from about 1.9 to 4, and (b) polyester polyols having a number averaged molecular weight of 1000 or more and a number average hydroxyl functionality of from about 1.9 to 4. Particularly preferred classes of isocyanate-terminated quasiprepolymers useful as the preferred quasiprepolymers in the present invention are MDI quasiprepolymers that are the reaction product of an excess of polymeric MDI (as the “base” polyisocyanate) and one or more polyether polyols. The polyether polyols are preferably diols, triols, and/or tetrols, individually having hydroxy values of 25 to 120. The overall polyol composition used in making these quasiprepolymers should have a number average molecular weight in the range of about 1000 to 3000. The preferred MDI series quasiprepolymers, useful in the adhesive systems and process according to the invention, should generally have a free-NCO content of more than about 10%, more preferably more than about 16% and most preferably about 16 to about 26%. By definition, these preferred quasiprepolymers contain some unreacted monomeric polyisocyanate species, in addition to the isocyanate group terminated prepolymer species themselves.

Although generally less preferred, it is possible to use true isocyanate group terminated prepolymers as the only isocyanate functional species present in the polyisocyanate adhesive. True prepolymers are, by definition, essentially free of residual monomeric polyisocyanate species. They are thus distinguished from the more desired quasiprepolymers by having a generally lower free —NCO group content by weight.

The polyol composition used in forming the most preferred quasiprepolymers contain at least one amine initiated aliphatic polyether polyol as described above. Suitable prepolymers are those in which the stoichiometric ratio of isocyanate (NCO) to hydroxyl (OH) exceeds 1:1. RUBINATE® polyisocyanate, available from Huntsman International LLC, is a non-limiting example of a suitable polymeric MDI composition useful in the preparation of polyisocyanate adhesives suitable for use in the adhesive systems and process of the present invention. This isocyanate product is by itself suitable as a polyisocyanate adhesive for use in the process according to the invention, although not generally as preferred as the quasiprepolymers prepared from it. In other embodiments, this polymeric MDI composition is combined with a minor amount of an MDI diisocyanate isomer or isomer mixture. An example of a preferred MDI diisocyanate isomer composition useful for this purpose is 4,4′-MDI. Most preferably, the base polyisocyanate composition used in making the preferred quasiprepolymer is a blend of polymeric MDI, such as the aforementioned RUBINATE® M polyisocyanate, and a pure MDI, such as 4,4′-MDI. Such blends have been found to provide improved penetration into lignocellulosic substrates and higher wood failure as opposed to glueline failure. A commercially available pure MDI product suitable for use in the present invention is RUBINATE® 44 isocyanate, available commercially from Huntsman International LLC. This is a 4,4′-MDI diisocyanate product. These base polyisocyanate blends preferably contain a ratio of the above-cited commercial polymeric MDI to the above-cited commercial pure MDI product in the range of about 95:5 to 50:50 and preferably 60:40 to 80:20, by weight.

The present polyisocyanate adhesive compositions may optionally further comprise various non-isocyanate-reactive compounds having a catalytic function to improve the cure rate of the adhesive system. Examples of appropriate catalysts suitable in this optional role are, for example, the non-isocyanate-reactive tertiary amine catalysts. By non-isocyanate-reactive, it is meant that the optional catalytic species is free of active hydrogen groups in the molecule. The optional catalyst is therefore quite distinct structurally from the desired amine-initiated polyols, but may be used in addition to these tertiary amine containing polyols as an additional source of catalytically effective aliphatic tertiary amine groups in the polyisocyanate adhesive. Suitable non-reactive tertiary amine catalysts are available commercially as, for example, NIAX® A-4 catalyst and NIAX® A-1, available commercially from OSI Specialties Division of Witco Corporation, and JEFFCAT® DMDEE catalyst available from Huntsman Petrochemical Corporation. When used in the polyisocyanate adhesive, the optional catalysts are preferably contained in an amount of from about 0.05 to about 2.0% by weight, preferably about 0.1 to about 1.0% by weight, and more preferably from about 0.25 to 0.7% by weight relative to the final total weight of the polyisocyanate adhesive composition.

The preferred quasiprepolymers may be prepared by simply mixing an excess of the base polyisocyanate composition and the polyol composition under suitable conditions to promote isocyanate-terminated prepolymer formation, particularly if both the base polyisocyanate and polyol compositions are liquids at 25° C. (as is preferably the case). No moisture should be allowed to enter the quasiprepolymer-forming reaction. If one of the precursor ingredients of the quasiprepolymer is a solid, that ingredient should be fully dissolved in the other (liquid) precursor ingredients. In any event, the components may be mixed or blended by any means evident to one skilled in the art from the present disclosure. The more preferred quasiprepolymers are liquid at 25° C., having a viscosity at 25° C. of less than 10,000 cps, and still more preferably less than 5000 cps, at 25° C. The polyols should preferably be fully reacted with the base polyisocyanate, in forming the quasiprepolymer. Examples of isocyanate functional quasiprepolymer compositions suitable for use in the polyisocyanate adhesive in the process of the present invention, and suitable methods for their preparation, are those described in the published international application WO-9510555, the full content of which is incorporated herein by reference.

An especially preferred subclass of polyisocyanate adhesive compositions useful in the polyisocyanate based adhesive systems and process according to the invention desirably contain a particulate filler dispersed therein. Conventional fillers, such as calcium carbonate, calcium oxide, clays, silica, silicates such as talc, and mixtures thereof are suitable for this optional purpose. The dispersed filler, if used, should be of a particle size that does not readily result in the bulk separation of the filler from the polyisocyanate dispersion on standing. The dispersion of the filler in the polyisocyanate composition should be stable to bulk separation for at least long enough to permit the storage of the adhesive, preferably without the need for continuous agitation thereof, for at least 24 hours under ambient conditions (protected from moisture). It is highly preferred that the final polyisocyanate adhesive (including any additives) used in the process of the invention should be storage stable at 25° C., without agitation, for at least 7 days, and more preferably at least 30 days, without bulk separation of the filler. The optimum average particle size needed to achieve the desired level of stability will depend upon the type of filler used.

In a preferred embodiment, a minor amount by weight relative to the total filler loading of CaO is pre-mixed with the other fillers, which consist essentially of talc, as a drying agent. This CaO drying operation is preferably conducted before the fillers are combined with the isocyanate group containing ingredients of the final polyisocyanate adhesive composition.

The fillers, when used, are generally added to the composition and mechanically mixed. Those skilled in the art will however appreciate many possible variations on the mixing procedure shown in these Examples.

The optional fillers have also been found useful to hold the adhesive on the surface of the substrate to be treated, thereby providing for a gap filling effect. A highly preferred class of particulate fillers includes talc, and mixtures of talc with calcium oxide. The preferred average particle size (average particle diameter) for these types of fillers is in the range of from 0.5 microns to 60 microns, but is more preferably in the range of from 1.0 microns to 5.0 microns. The optional talc/calcium oxide mixtures in this embodiment are particularly preferred because the calcium oxide serves as a drying agent, to remove any available water from the surface of the talc, and prevent if from reacting with the free isocyanate groups present in the polyisocyanate adhesive. It is highly desirable that any filler used should be sufficiently free of available water so that the final adhesive composition remains sufficiently free of gels and of low enough viscosity to permit application of the final adhesive composition onto substrates and to be consistent with the desired degree of shelf stability. The amount of the particulate filler by weight relative to the final polyisocyanate adhesive composition may vary considerably depending upon the types of optional particulate fillers used. Effective amounts of filler may extend from as little as 1% by weight to as much as 50% by weight, but is preferably in the range of about 2 to 30%, more preferably 5 to 25%, still more preferably 5 to 20%, even more preferably 10 to 20%, and most preferably 12 to 18% by weight of the total polyisocyanate adhesive composition.

A subclass of polyisocyanate adhesive compositions preferred for use in the adhesive systems and process of the invention contain an inert fatty ester. The fatty ester, when used, may be a single compound or a mixture of such compounds, but is preferred to be predominantly aliphatic fatty esters by weight. More preferably, the inert fatty ester component is entirely aliphatic. The term “inert”, as applied to the optional fatty ester component, it is meant to indicate that the fatty ester component is essentially free of molecular species containing groups reactive towards isocyanates under the conditions of blend preparation or storage of the blend. By “essentially free” it is meant that the fatty ester component contains less than 10% by weight, preferably less than 5% by weight, more preferably less than 3% by weight, still more preferably less than 2% by weight, even more preferably less than 1% by weight, most preferably less than 0.5%, and ideally less than 0.1% by weight of molecular species bearing functional groups reactive towards the isocyanate species present under the conditions of blend preparation or storage.

The optional fatty ester ingredient in the polyisocyanate adhesive should be substantially non-volatile. By the term “substantially non-volatile” it is meant that the fatty ester component is essentially free of compounds boiling lower than 200° C. at 1 standard atmosphere pressure (760 mmHg). More preferably, the fatty ester is essentially free of compounds boiling lower than 250° C. at 1 atmosphere pressure. Still more preferably, the optional fatty ester component is essentially free of compounds boiling lower than 300° C. at 1 atmosphere pressure. Even more preferably, the fatty ester component is essentially free of compounds boiling below 350° C. at 1 atmosphere pressure. Most preferably, the fatty ester component is essentially free of compounds boiling lower than 400° C. at 1 atmosphere pressure. By “essentially free” it is meant that the fatty ester component contains less than 10% by weight, preferably less than 5% by weight, more preferably less than 3% by weight, still more preferably less than 2% by weight, even more preferably less than 1% by weight, most preferably less than 0.5%, and ideally less than 0.1% by weight of compounds (molecular species) having boiling points lower than the boiling point indicated. The essential absence of low boiling species in the optional fatty ester component should result in a fatty ester component which is characterized by having its initial boiling point at 1 atmosphere pressure of at least 125° C., more preferably at least 150° C., still more preferably at least 180° C., even more preferably at least 200° C., and most preferably greater than 200° C.

The optional fatty ester component should be soluble in the said isocyanate-containing species, and more preferably is miscible with the polyisocyanates in all proportions at 25° C. The fatty ester component is preferably a liquid at 25° C. The fatty ester component preferably has a viscosity at 25° C. that is lower than that of the combined polyisocyanate species, at 25° C. The optional fatty ester component desirably comprises at least one fatty ester compound of 20 carbons or more, preferably of 30 carbons or more. The individual compounds present in the inert fatty ester component composition more preferably contain at least 20 carbon atoms, and most preferably at least 30 carbon atoms.

A preferred class of compounds suitable for use as the optional fatty ester component are inert triglyceride oils, or mixtures of such triglyceride oils. Other types of optional fatty ester compounds may be used if desired, either instead of or in addition to triglyceride oils. The triglyceride oils, when used in the polyisocyanate adhesive, are preferably liquid at 25° C. and have a viscosity lower than that of the combined polyisocyanate species present, at 25° C. The triglyceride oils, when used, preferably consist essentially of organic aliphatic molecular species having at least 33 carbon atoms and at least one triglyceride ester moiety. The more preferred triglyceride oils consist essentially of molecular species having greater than 50 carbon atoms. The more preferred triglyceride oils are the triglycerides of aliphatic fatty acids having between 10 and 25 carbon atoms. Still more preferred are the triglycerides of aliphatic fatty acids having from 16 to 20 carbon atoms. The most preferred of the optional triglycerides are triglycerides of C-18 fatty acids wherein at least one of the said C-18 fatty acid units per triglyceride molecule contains at least one unit of ethylenic unsaturation. The most preferred triglyceride oils contain a plurality of units of ethylenic unsaturation per molecule. Non-limiting examples of highly preferred optional triglyceride oils include liquid vegetable oils such as linseed oil and soy oil. Soy oil is particularly preferred. An example of a commercial soy oil product is RBD® SOYBEAN OIL, from Archer Daniels Midland Corporation.

An example of a preferred grade of linseed oil is a dewaxed linseed oil. Dewaxed linseed oil compositions are known in the art and available commercially. Other dewaxed liquid vegetable oils may also be used as the optional triglyceride oil in the adhesive compositions useful in the invention. Dewaxed vegetable oils have been treated to remove most of the solid waxy impurities that are sometimes present in raw vegetable oil. A specific example of a dewaxed linseed oil product suitable for use in the polyisocyanate adhesive composition is SUPERB® linseed oil, which is commercially available from the Archer Daniels Midland Corporation. Crude linseed may also be used, if desired. Likewise, crude soybean oil may be used. A specific example of a crude linseed oil product that is suitable for use is “raw” linseed oil, which is commercially available from the Archer Daniels Midland Corporation.

The liquid triglyceride oil most preferably has a viscosity (at 25° C.) that is less than the viscosity of the combined polyisocyanate species present in the adhesive with which it is to be blended (also measured at 25° C.). The blend of the combined polyisocyanate species with the triglyceride oil is most preferably lower in viscosity than the combined polyisocyanate species by itself (compared at 25° C.).

The optional triglyceride oil is preferred to be substantially free of compounds that are not aliphatic triglycerides. By “aliphatic triglyceride” is meant a compound that contains at least one triglyceride unit, and preferably only one triglyceride unit, and is free of aromatic rings. By “substantially free” in this context it is meant that the triglyceride oil contains less than 20% by weight of non-triglyceride compounds, preferably less than 15% by weight, more preferably less than 10% by weight, still more preferably less than 5% by weight, most preferably less than 2% by weight, and ideally less than 1% by weight of non-triglyceride compounds.

The preferred triglyceride oils suitable for use as optional additives in the polyisocyanate can be used to dilute monomeric (base) polyisocyanates, or for the more preferred quasiprepolymer polyisocyanates comprising the isocyanate terminated prepolymer species. Any suitable order of addition of the various ingredients, in forming the final polyisocyanate adhesive, is acceptable as long as it results in a useable adhesive composition. The more preferred blends are made from the polyisocyanate compositions comprising isocyanate terminated prepolymer species and monomeric polyisocyanate species (i.e. quasiprepolymers).

The preferred optional triglyceride oils are non-toxic natural products that substantially non-volatile and substantially free of offensive odors. Mixtures of different inert triglyceride oils may of course be used if desired.

The total level of the optional inert fatty ester component, when used, in the final polyisocyanate adhesive composition is preferably in the range of from 1 to 30% by weight of the said final polyisocyanate adhesive. More preferably, the level is from 2 to 25%, still more preferably from 3 to 20%, even more preferably from 4 to 15%, and most preferably from 5 to 12% of the said final (i.e. total) polyisocyanate adhesive composition by weight.

Also, it may sometimes be necessary to utilize additional optional dilutants and/or wetting agents in the final polyisocyanate adhesive composition in order to modify the viscosity of the adhesive composition. These materials are used in amounts appropriate for specific applications, which will be evident to one skilled in the art based on the present disclosure. Alkylene carbonates, such as propylene carbonate, may be particularly useful as an additive in some adhesive formulations. This inert and relatively high boiling compound can be useful for improving the stability of the final adhesive composition, with respect to separation. The optional additional additives, if used at all, should preferably be present at low levels.

In a preferred embodiment, the final polyisocyanate adhesive compositions, as used in the polyisocyanate based adhesive systems and in the process of the invention, are (including any optional additives) preferably liquids at 25° C. The viscosity of the final adhesive composition is preferably less than 12,000 cps at 25° C., more preferably less than 10,000 cps, still more preferably less than 7000 cps, even more preferably less than 5000 cps, and most preferably less than 4000 cps at 25° C. The said polyisocyanate adhesive compositions are further preferably stable with respect to bulk separation of the particulate filler (where fillers are used), gel formation, and substantial increase in viscosity during storage under dry conditions at 25° C. The viscosity should not increase above usable levels, as indicated above, during storage for at least 24 hours and preferably for more than 24 hours.

In another particularly preferred embodiment, the organic polyisocyanate composition may comprise a finely dispersed crystalline or semicrystalline organic solid material. These crystalline or semicrystalline organic solids, much like the inorganic fillers discussed above, provide the adhesive with gap filling properties which are highly desirable. However, these fine particulate organic dispersions in the polyisocyanate component also dramatically improve the bond strength and bond durability of the adhesive. The extent of the improvement is unexpected and surprising, and may permit the formulation of organic polyisocyanate adhesives that pass all the requirements of ASTM D-2559-00 Section 14 and/or ASTM D-2559-00 Sections 14 and 15 without the need for any optional adhesion promoter. The most preferred of these organic crystalline or semicrystalline dispersion modified polyisocyanate adhesives are one-component adhesives, and do not require any co-adhesives. They have the potential of being used on a “stand alone” basis. It may be preferable in some embodiments of the invention, from the standpoint of process simplicity and cost, to use a stand-alone one-component adhesive which is storage stable and does not require any adhesion promoters or co-adhesives to achieve a successful outcome. The preferred stand-alone one-component polyisocyanate adhesives according to the invention are storage stable for greater than 24 hours, and generally also for greater than 7 days, under ambient conditions (when protected from moisture). It would, of course, be within the broader scope of the invention to use these highly preferred stand-alone polyisocyanate adhesives with the optional adhesion promoters. The use of an optional adhesion promoter may be desirable, even with these crystalline or semicrystalline dispersion modified polyisocyanate adhesives, because the combination will provide better reliability in production than the modified polyisocyanate alone. The organic polyisocyanate adhesives of this type may be solid or semi-solid at 25° C., and may require heating in order to facilitate application thereof as liquids. The application of a liquid polyisocyanate adhesive to the lignocellulosic substrate(s) is the preferred mode of application. However, application of the adhesives as pastes, or even as solids, is within the broader scope of the invention, provided that the required properties of the resulting adhesive bond are achieved. The crystalline or semicrystalline dispersed organic phase within these preferred polyisocyanate adhesives are capable of forming crystalline or semicrystalline domains at least at 25° C., more preferably up to at least about 30° C., and even more preferably up to at least about 40° C. at 1 standard atmosphere pressure (760 mmHg). The crystallinity may disappear however when the adhesive is heated to facilitate application to the substrate, but reappears when the adhesive or its cured reaction product is returned to ambient conditions. Although not wanting to be bound to any theory, it is believed that the crystalline or semicrystalline dispersed organic domains help to diffuse fracture energy, thereby improved the strength and damage tolerance of the adhesive bond. The dispersed organic phase also reduces foaming of the isocyanate adhesive in gaps, thereby increasing the strength of the adhesive bond and reducing the occurrence of defects that might act as sites of stress concentration. The decrease in foaming is particularly noticeable when the crystalline or semicrystalline organic dispersion modified isocyanate adhesive is applied to the substrate in a semi-solid (paste like) state, as opposed to a fully molten state. Application of these adhesives in the paste like state, wherein at least some of the crystalline or semicrystalline domains are intact, is therefore preferred to application in the fully molten state. Non-limiting examples of preferred dispersed phases which have crystalline or semicrystalline character under ambient conditions include high molecular weight polycaprolactone polymer segments, and certain polyethylene powders. It is highly preferred that the particulate crystalline or semicrystalline phases in these polyisocyanate adhesives be finely dispersed and have some degree of direct (preferably covalent) surface bonding to the polyisocyanate. In one non-limiting example of a highly preferred embodiment, a 50,000 MW (number averaged) polycaprolactone diol is melt dispersed into a quasiprepolymer polyisocyanate. The more preferred qualiprepolymer polyisocyanates in this embodiment contain a tertiary amine initiated polyol, as described previously. The terminal hydroxyl groups on the high molecular weight polycaprolactone provide for reaction with free isocyanate groups during the melt dispersion process. The resulting dispersion continues to have free isocyanate groups. The polycaprolactone phase retains some degree of crystallinity at least under ambient conditions. In yet another preferred non-limiting example, a surface treated finely powdered polyethylene is used as the dispersed crystalline or semicrystalline organic phase, in the same quasiprepolymer polyisocyanate. The surface treatment of the powdered polyethylene provides for wetting, and possibly bonding, to the polyisocyanate. Combinations of the high MW polycaprolactone and the surface treated polyethylene powder may also be used, with good results. The total loading of the dispersed crystalline or semicrystalline phase is typically between about 1% and 25% by weight of the total polyisocyanate adhesive composition (including said dispersed phase). More preferably, this loading is from about 3% to about 20% by weight, and most preferably from about 5% to 12% by weight. These dispersions typically have a paste like consistency under ambient conditions but are flowable liquids when heated. Combinations of organic and inorganic fillers may be used if desired. However, it is generally preferred to use one or the other. Both types of dispersed phases provide for improved gap filling ability and reduced tendency for foaming of the adhesive during the cure thereof. These characteristics are highly desirable.

The amount of the polyisocyanate adhesive that should be applied to the substrate should be just high enough to assure that the bond is sufficiently strong and durable to pass all the requirements of ASTM D-2559-00 Section 14 and/or ASTM D-2559-00 Sections 14 and 15. Use of higher levels is uneconomical for many applications, but may nevertheless be justified in certain specialized applications and would be within the scope of the invention. The optimum amount will depend on the type of polyisocyanate adhesive used, on the wood species, and on the presence and type of any optional adhesion promoters used. The polyisocyanate adhesives which have been modified with a crystalline or semicrystalline organic phase, as described above, generally exhibit improved bond strength and durability as the loading of the polyisocyanate on the substrate is increased. This is believed to be due, at least in part, to the gap filling nature of these adhesives. However, other types of polyisocyanate adhesives within the scope of the invention generally do no exhibit a monotonic increase in bond strength and durability as the adhesive loading increased. These more conventional types of polyisocyanate adhesives may not pass all the requirements of ASTM D-2559-00 Section 14 and/or ASTM D-2559-00 Sections 14 and 15 at any loading, without using appropriate methods of surface preparation which may or may not involve the use of the optional adhesion promoter constituent of the overall polyisocyanate-based adhesive system. In these situations the adhesion promoter is not optional. There may also be situations wherein the use of an optional adhesion promoter can improve the adhesive performance of a “stand alone” (crystalline or semicrystalline organic dispersion modified) polyisocyanate adhesive so as to improve the overall economics of the bonding process while still passing the all the requirements of adhesive bond quality.

The typical loading of the polyisocyanate adhesive ranges from about 4 to about 40 pounds per 1000 square feet of bond interface, but, more preferably, from about 8 to about 40 pounds per 1000 square feet of bond interface. These ranges generally apply whether or not an optional adhesion promoter is used in the overall adhesive system. The expression “bond interface” (or “interface”) denotes the area of overlap between the adherends, and not the sum of the areas of the surfaces to be bonded.

The adhesive systems disclosed herein may contain an optional surface treatment. According to this optional mode of practicing the invention, the surface of at least one of the substrates to be bonded is treated with an effective amount of an adhesion promoting composition, and preferably both surfaces. In the more preferred embodiments, the adhesion promoting composition is a liquid, most preferably an aqueous solution or an aqueous latex dispersion. The surface of at least one of the substrates to be bonded is treated with an effective amount of a polyisocyanate adhesive composition. The bonding surfaces treated with the surface treatment and with the polyisocyanate composition may be the same or different. The surfaces of the treated substrates to be bonded are brought into direct contact, wherein said polyisocyanate adhesive composition is caused to come into contact with at least a portion of said adhesion promoting composition under conditions suitable for the formation of an adhesive bond between said surfaces. An adhesive bond is allowed to form between the surfaces.

The adhesion promoting composition is preferred to be a completely separate entity from the polyisocyanate adhesive composition. These two compositions are preferably applied to the substrate separately. However, it would be possible to form a premix of the liquid adhesion promoting composition with the polyisocyanate adhesive composition, under the proviso that there is substantially no reaction between the active ingredients present in the adhesion promoting composition and the isocyanate species present before the premix is applied to the substrate. It is, for example, possible to form aqueous metastable emulsions of certain polyisocyanate adhesives in water, while maintaining a substantial amount of the free isocyanate groups present in the latter, and then using this free isocyanate group containing emulsion as the adhesive. These “emulsifiable polyisocyanate” adhesives are known in the art as wood adhesives, and their use would be within the scope of some embodiments of the invention, although certainly not required for the successful practice of the invention. In the more preferred embodiments, the polyisocyanate composition is applied “neat” (not emulsified or diluted with water), whether or not a (separate) adhesion promoter is used. It would also be within the scope of the invention to include all or part of the optional adhesion promoter into the aqueous phase of a polyisocyanate adhesive emulsion, under the proviso that there is substantially no reaction between the adhesion promoter and the polyisocyanate prior to application of the emulsion to the lignocellulosic substrate.

Many different types of optional adhesion promoters may be used. The preferred adhesion promoters are liquid aqueous solutions of organic compounds or organic polymers that work synergistically with the polyisocyanate adhesive composition and the specific wood species being bonded. The optimum adhesion promoting composition for one wood species may not be optimal for another. For example, it has been found that simple urea, in aqueous solution, is particularly effective for laminating southern yellow pine (SYP). Aqueous solutions of polyvinyl alcohol (PVA), or aqueous latex of carboxylated poly(ethylene-co-vinyl acetate) are especially effective for lamination of Douglas fir. These aqueous adhesion promoters have the advantage of being indefinitely stable in dilute aqueous solutions, suitable for use in practicing the invention. However, it is within the scope of the invention to use other kinds of optional adhesion promoters, or to use mixtures of different adhesion promoters, provided that these satisfy the constraints stated herein. Likewise, the amount of the adhesion promoter applied to the surfaces to be bonded, and the concentration of the active adhesion promoting species applied (i.e. from aqueous solution) are optimized to provide adhesive bonds, in the final lignocellulosic composite articles, which are capable of passing all the requirements of ASTM D-2559-00 Section 14 and/or ASTM D-2559-00 Sections 14 and 15. This simple optimization would be well within the capabilities of those skilled in the art without undue experimentation. The working Examples, provided below, contain additional information on how best to use the adhesive systems and practice the process.

In industrial practice, the surfaces of lignocellulosic adherends are sometimes sprayed with water, in conjunction with the use of polyisocyanate adhesives. The substitution of a storage stable aqueous urea or PVA solution for plain water in these operations is a particularly simple process modification that can result in an objective measurable improvement in adhesion performance relative to the same system without the adhesion promoter solution present. In fact, depending upon the polyisocyanate composition used, it can make the difference between passing or failing the requirement of ASTM D-2559-00 Section 14 and/or ASTM D-2559-00 Sections 14 and 15.

The polyisocyanate adhesive must be applied in an amount effective to produce adhesion between two substrates. It must be applied to at least one of the substrates to be bonded in forming the composite, but may be applied to more than one of the substrates, if desired. It must come into adhesive contact with at least one of the lignocellulosic substrates to be bonded during the formation of the composite. Moreover, it is critical the that the polyisocyanate adhesive come into adhesive contact with at least one of the lignocellulosic substrates to be bonded, wherein the substrate has also been treated with the adhesion promoting composition, when the polyisocyanate adhesive composition is not sufficiently effective by itself. In situations where the polyisocyanate adhesive composition is not capable of passing the requirements of ASTM D-2559-00 Section 14 and/or ASTM D-2559-00 Sections 14 and 15 when applied alone, the additional use of the adhesion promoter becomes essential to the successful practice of an embodiment of the invention. The interaction between the polyisocyanate adhesive composition and at least one such adhesion promoter treated lignocellulosic substrate can result in significantly enhanced adhesion performance. This interaction should be provided for before the adhesive is fully cured in order to be most effective.

The person skilled in the art will recognize many ways of achieving the necessary and effective contact between the polyisocyanate adhesive and the adhesion promoter treated lignocellulosic surface(s) to be bonded. A non-limiting example of one such method would be to apply the polyisocyanate adhesive directly to a lignocellulosic surface after the latter surface has been treated with the liquid adhesion promoting composition. After application of the adhesive, the lignocellulosic surface may then be placed in contact with another surface under conditions that promote adhesive bonding thereto. In a preferred embodiment, the second surface is also a lignocellulosic surface that has itself been treated with an adhesion promoting composition. In another non-limiting example, the polyisocyanate adhesive may be first applied to the surface of a substrate to be bonded, and the adhesive treated surface then placed into adhesive contact with a lignocellulosic surface that has been treated with an adhesion promoting composition. In yet another non-limiting example, two adhesion promoter treated lignocellulosic surfaces are each coated with the polyisocyanate adhesive composition, and the said surfaces are then placed into adhesive contact with each other. Those skilled in the art will appreciate many variations on these examples within the scope of the invention.

The polyisocyanate adhesive may be applied to surfaces by any of the suitable methods known in the art for the application of these kinds of adhesives. These application methods, include, but are not limited to, brushing, spraying, doctor blading, rolling, ribbon coating, and combinations of these different methods. Especially preferred methods include spraying and ribbon coating.

The extent of adhesive coverage of the surfaces to be bonded may be partial or complete. The extent of treatment of the lignocellulosic bonding surfaces by the adhesion promoter may also be partial or complete. Likewise, the extent of overlap between the polyisocyanate adhesive and the lignocellulosic surfaces that have been treated with optional adhesion promoter, when used, may be partial or complete. It is preferable that the extent of this overlap be maximized on the bonding surfaces. Those skilled in the art will appreciate means for maximizing this overlap in preparing the adhesive bond.

After the adhesive and the adhesion promoter composition have been applied to the substrates to be bonded, the surfaces of these substrates are placed into adhesive contact, preferably under conditions that maximize the overlap of the polyisocyanate adhesive with the areas that have been treated with the optional adhesion promoter composition, when the adhesion promoter is used. The formation of the adhesive bond is further promoted by conditions that facilitate the cure of the polyisocyanate adhesive in intimate contact with the bonding surfaces. These conditions generally involve the application of pressure and/or heat to the bonding surfaces. Cure of the polyisocyanate adhesive is also facilitated by the presence of moisture at the site of adhesive bonding. Lignocellulosic substrates usually contain moisture, and sometimes it is preferred to add additional moisture to one or more of the surfaces to be bonded.

Pressure may be applied by placing the substrates to be bonded in a press, or by using a jig or a clamping means, in order to force the bonding surfaces into more intimate contact. The use of pressure is generally preferred. Heat may also be applied in order to accelerate cure. When heating is applied it is most preferably used in combination with pressure. The application of heat may be accomplished for example by using a heated press, by using an oven, by applying radiation (such as infrared, RF, or microwaves), by injecting steam, by use of a stream of hot air, or by combinations of these methods, and the like.

In an especially preferred embodiment, the formation of the adhesive bond is accomplished at ambient temperature. This preferred “cold curing” mode is accomplished by the combination of pressure and moisture, without external heating. It is a particularly desirable method of curing in engineered lumber applications, such as the formation of thick laminated beams and adhesive bonded I-joists.

Those skilled in the art will appreciate that the details of the curing conditions and the length of time that they must be applied in order to achieve an optimal adhesive bond will vary considerably with the formulation of the polyisocyanate adhesive, the nature of the substrates to be bonded, the type of composite being produced, the level and distribution of both the adhesive and the adhesion promoter used, and many other known factors. Cure conditions for each bonding situation must be optimized independently.

It is within the broader scope of the invention to employ other adhesive components in addition to the required polyisocyanate based adhesive system. The polyisocyanate based adhesive systems may, for example, be used in combination with a phenolic resin, an unsaturated polyester resin, an epoxy resin, or any other non-isocyanate based co-adhesive system. The optional non-isocyanate based co-adhesive may, if used, be applied to the substrates separately from the polyisocyanate adhesive, or together with the polyisocyanate adhesive if this is technically practical. Co-adhesives, such as those listed above, are not required for the successful practice of the invention and add undesirable complexity to the manufacturing process.

It is also within the broader scope of the invention to use “two component” adhesives, wherein the polyisocyanate adhesive constituent of the overall adhesive system is brought into reactive contact with a polyfunctional organic isocyanate-reactive material, such as a polyol or polyol blend, during the formation of the adhesive bond. In this optional two component mode the organic polyisocyanate is mixed with the optional isocyanate-reactive organic material either on the surface of the bonding substrates or during the application process. The combining of the two components is usually done at a well-defined and predetermined ratio of the said components. Reaction between these two components occurs primarily in contact with the surfaces to be bonded. The use of two component adhesives is generally less preferred because of the need to carefully control the component ratios, and to keep the components separated until application to the substrate. This adds to the complexity of the adhesive bonding process. The use of two component or multi-component technology is not required for the successful practice of the invention.

In the preferred embodiments, the polyisocyanate adhesive is the sole adhesive resin used. The most preferred polyisocyanate adhesive composition is said to be a “one component” adhesive. Cure of this one component adhesive is facilitated by contact with moisture on the substrate, and by the presence of isocyanate reactive groups in or on the substrates to be bonded.

At this point, an important distinction needs to be made between an adhesive system that involves an (optional) adhesion promoter, and one that involves multiple adhesive components. When working with polyisocyanate based adhesive chemistry, the use of a second (or more) reactive components requires a precise control over the ratio of reactive groups (i.e. the ratio of isocyanate groups to polymer-forming active hydrogen groups in the additional reactive components). The optional adhesion promoters, as used in the present invention, do not require precise control over the ratios of reactive functional groups. The optional adhesion promoters may be applied from aqueous solution by brushing, rolling, spraying, wiping, or other techniques that do not require exact metering of the amounts by weight. This leads to considerable process simplification. There is considerable flexibility in the amount of adhesion promoter that can be applied to the substrate, and still result in a successful outcome.

Although the role of the optional adhesion promoters in the curing process is not precisely understood, it is possible that it may be directly involved in reactions with the polyisocyanate adhesive on the substrates to be bonded. Although not wishing to be bound by any theory, it is also possible that at least some of the adhesion promoters may simply be changing the characteristics of the wood surface in ways that enhance bonding thereto by the polyisocyanate, rather that participating in the bond directly. In the preferred “one component” embodiment there are substantially no other isocyanate reactive materials introduced.

It has been unexpectedly and surprisingly found that the use of the adhesion promoting compositions according to the process of the invention can significantly improve bond quality in lignocellulosic composites made with polyisocyanate one-component adhesives. The process disclosed herein may be used to produce adhesive bonded lignocellulosic composites with improved bond quality without increasing the adhesive loading. The process may also, in some cases, be used to improve the economics of the adhesive bonding process by reducing the amount of the polyisocyanate adhesive required to achieve a level of bond quality required to meet the requirements of ASTM D-2559-00 Section 14 and/or ASTM D-2559-00 Sections 14 and 15. The preferred adhesion promoters are very low in cost, easy to apply, and generally free of the health and safety concerns associated with prior art adhesion promoters. The preferred adhesion promoting compositions are particularly well suited to the production of engineered lumber composites. The process disclosed herein is simple and inexpensive to implement because precise control of the ratio of the adhesion promoter to the polyisocyanate adhesive is not necessary.

When an optional adhesion promoter is used, at least one of the lignocellulosic surfaces to be bonded together in the construction of the lignocellulosic composites must be treated with an adhesion promoting composition (desirably a liquid composition).

In one highly preferred embodiment, the liquid adhesion promoting composition comprises an effective adhesion promoting amount of at least one monomeric urea. In a particularly preferred embodiment, the monomeric urea is simple urea (H₂N—CO—NH₂) and the liquid adhesion promoting composition is a solution of simple urea in water. Most preferably, the urea is completely dissolved in the water and the solution is then applied to the lignocellulosic surface(s). However, it is possible to use a urea solution in which the urea is not fully dissolved, or to apply all or part of the urea to the surface of the lignocellulosic substrate(s) as a solid, preferably in powered form, and then treat the same surface(s) with water in order to at least partially dissolve the urea and thereby form the adhesion promoting solution in situ. One or more combinations of these approaches may also be used, if desired.

It has been noted that the urea solution works surprisingly well on southern yellow pine, but evidently not as well on Douglas fir substrates. Other adhesion promoters, such as aqueous PVA, have been noted to work surprisingly well on both Douglas fir and southern yellow pine. Still other adhesion promoters, such as AIRFLEX® 426 promoter, for example, work surprisingly well on Douglas fir (DF), but evidently not as well on southern yellow pine (SYP).

The preferred aqueous solution of the adhesion promoter, such as urea, may be applied to the substrate by any known method, including, but not limited to, dip coating, rolling, doctor blading, spraying, or any combination of these. The most preferred application method is spraying.

If desired, the urea solution may contain an optional wetting agent in an amount suitable for improving the wetting of the substrate by the said urea solution. The optional wetting agent, if used, should preferably be a minor component of the solution by weight, relative to the weight of the urea present. A non-limiting example of a suitable optional wetting agent for this purpose is a dodecylbenzene sulfonic acid salt, particularly the sodium salt. This, or other, optional wetting agents may also be used with other kinds of adhesion promoters in relatively minor amounts, if desired in order to improve surface wetting.

The urea solution in this preferred embodiment should preferably be applied to the surfaces of the lignocellulosic substrates most likely to come into adhesive contact with the polyisocyanate adhesive, but it would be within the scope of the invention to treat other areas of the substrate (not likely to participate in the final adhesive bond) also if desired. Selective treatment of the substrate with the adhesion promoting urea solution is preferred.

Although the most preferred urea is simple urea, for reasons of cost and safety, it is also possible to use one or more other monomeric urea compounds, either alone or in combination with simple urea. The monomeric ureas however should not include resin forming or polymeric ureas such as urea-formaldehyde (UF) resins. Adducts of urea and formaldehyde should be substantially absent because they present concerns about unwanted emissions of formaldehyde. Examples of monomeric urea compounds that may be used include simple urea (which is most preferred), mono and polyalkylated ureas, cyclic alkylene ureas, aromatic ureas, alkoxylated ureas, and mixtures thereof. The ureas should preferably be soluble in water, in effective adhesion promoting amounts. The use of solvents other than water is highly undesirable. The successful practice of the present invention does not require the use of solvents other than water. The preferred monomeric ureas are substantially free of species containing more than one urea group per molecule.

A urea group is understood herein to be distinct from a biuret group, a triuret group, a polyuret group, or a cyanurate group.

Other adhesion promoting substances may of course be used in combination with the monomeric urea(s) if desired, but this is generally not necessary, not desirable, and usually not cost effective. In a preferred embodiment, the monomeric urea(s) are the predominant adhesion promoters present in the liquid adhesion promoting composition, by weight. In a more preferred embodiment, the liquid adhesion promoting composition is essentially free of adhesion promoters other than the monomeric urea(s). The urea adhesion promoters, particularly urea itself, have been found to be particularly effective in bonding lignocellulosic surfaces that comprise southern yellow pine. Urea works synergistically with this wood species.

Ureas are not the only types of optional adhesion promoters that can be used successfully in the practice of the invention. Other highly preferred non-limiting examples of optional adhesion promoters include polyvinyl alcohol (PVA) and vinyl acetate copolymers. A preferred example of the former is ELVANOL® 75-15 polyvinyl alcohol, available from Du Pont Corporation. A preferred example of the latter is AIRFLEX® 426 vinyl acetate copolymers, which is a carboxylated poly(ethylene-co-vinyl acetate) available from Air Products and Chemicals Corporation. These polymeric adhesion promoters are water soluble and, as in the case of simple urea, are preferably applied directly to the lignocellulosic surface(s) to be bonded as aqueous solutions (typically about 1% by weight concentration of the active adhesion promoter in water). The more preferred adhesion promoters are water soluble or water dispersible, and stable in aqueous solution for at least 24 hours, and preferably at least 7 days, under ambient conditions, prior to application to the substrate. They most preferably do not require any special handling or storage, and are characterized by the absence of a critical “use window” (or period of time during which the adhesion promoter solution must be used in order to achieve a successful adhesive bond). As with the ureas, it may sometimes be desirable to include an optional wetting agent, in minor amounts, in the aqueous solutions of these polymeric adhesion promoters. The PVAC type polymeric adhesion promoters have been observed to have a unique synergy with Douglass fir substrates, but are evidently not as effective on southern yellow pine.

As with the urea type adhesion promoters, it would be within the broader scope of the invention to apply the polymeric adhesion promoters (such as the PVA and PVAC types) directly onto the substrate in solid form, and then dilute with water. However, this mode of application is more complicated and generally much less preferred. Likewise, the possible modes of application discussed above for the ureas will also be applicable to these polymeric adhesion promoters, especially as aqueous solutions. Spraying is, once again, a particularly preferred and convenient mode of application.

Other kinds of adhesion promoters that may be used include, but are not limited to, hydrolyzed or partially hydrolyzed aqueous solutions of amino functional silanes. Examples of the latter include gamma amino trialkoxysilanes that have been hydrolyzed or partially hydrolyzed in aqueous solution.

When the optional adhesion promoter is used as part of the overall adhesive system, the typical loading (of the active adhesion promoting ingredients) ranges from about 0.02 to about 3.0 pounds per 1000 square feet of bond interface, but a more preferred range extends from about 0.1 to about 1.0 pounds per 1000 square feet of bond interface, and most preferably from about 0.4 to about 0.6 pounds per 1000 square feet of bond interface. These weights do not include the carrier used to apply the adhesion promoter (which is just water, in the most preferred cases). The meaning of the term “bond interface” (or simply “interface”) is as defined previously.

Many of the preferred adhesion promoters, such as simple urea, are considerably less expensive than the organic polyisocyanate constituent of the overall adhesive system. Whenever this is true, it is advantageous to minimize the use of the polyisocyanate constituent as much as possible by using the adhesion promoter constituent of the overall adhesive system according to the invention. This sort of simple optimization of usage levels will be well understood by those skilled in the art, with the aid of the working Examples which follow.

The invention further provides adhesive bonded articles prepared according to the process described herein. The invention still further provides optional adhesion promoting compositions suitable for use with polyisocyanate adhesives.

The following examples are illustrative of the present invention, and are not intended to limit the scope of the invention in any way.

### EXAMPLES

Amounts of ingredients shown below are by weight unless otherwise indicated. The expression “#/msf” denotes “pounds per 1000 square feet” of bond interface. The expression “interface” (or “bond interface”) denotes bonding interface between two lignocellulosic substrates. The surface area of the interface is equal to the area of overlap between two adherends (i.e. the area over which the two surfaces are in contact), and not the total surface area of the adherends.

Glossary:

1) LINESTAR® 4605 adhesive: A quasiprepolymer polyisocyanate adhesive available from Huntsman International LLC. This organic polyisocyanate composition is an isocyanate functional quasiprepolymer derived from the reaction of a polyol combination comprising an amine initiated polyether polyol with a base polyisocyanate consisting essentially of a combination of polyisocyanates of the MDI series. It has a free —NCO group content of about 19% by weight.
2) LINESTAR® 4675 adhesive: A quasiprepolymer polyisocyanate adhesive that has been modified with an inert triglyceride oil and inorganic fillers. The quasiprepolymer polyisocyanate, prior to this modification, is LINESTAR® 4605. The free —NCO group content of LINESTAR® 4675 is about 14.6% by weight.
3) LINESTAR® 4800 adhesive: A quasiprepolymer polyisocyanate adhesive available from Huntsman International LLC. This organic polyisocyanate composition is an isocyanate functional quasiprepolymer derived from the reaction of a polyol combination comprising an amine initiated polyether polyol with a base polyisocyanate consisting essentially of a combination of polyisocyanates of the MDI series.
4) RUBINOL® ST010 surface treatment: Is a 1% by weight solution of simple urea in water, available from Huntsman International LLC.
5) AIRFLEX® 426 surface treatment precursor: A carboxylated poly(ethylene-co-vinyl acetate) copolymer from Air Products and Chemicals Inc., 63% solids in water emulsion.
6) ELVANOL® 75-15 surface treatment: A 1% by weight solution of polyvinyl alcohol (PVA; available from Du Pont Chemical Company) in water.
7) CAPA® 6501 high molecular weight polycaprolactone: A polycaprolactone diol of number averaged molecular weight (Mn) 50,000; from Solvay Corporation.
8) Dodecylbenzene sulfonate sodium salt: An optional wetting agent obtained from Aldrich Chemical, catalog number 28,995-7 (from the 2000-2001 Aldrich catalog); CAS #25155-30-0.

The wood used in examples 1 through 6 was prepared with a planed surface.

### Example 1

In this Example, it is surprisingly found that an aminosilane, which has the ability to self-polymerize, performs no better than simple urea as adhesion promoter on Southern Yellow Pine. Also, given that the improvement does not seem to be specific to acid or base (compare results obtained with acetic acid, and with sodium hydroxide), there is no reason for one to have anticipated that urea would work as an adhesion promoter.

The Effect of Surface Treatment on Bond Strength of Southern Yellow Pine.

The bond strength of a one-part moisture curable adhesive (LINESTAR® 4605 adhesive) to Southern Yellow Pine (SYP) was evaluated with and without the use of various wood surface treatments (via a compressive shear test similar to that described in ASTM D2559). 2″×2″×¾″ SYP blocks were separated into pairs, and were pre-conditioned for 24 hours under ambient laboratory conditions (23° C., approximately 25% RH) prior to treatment.

The “surface treatment compounds” for this example are provided in Table 1 together with other materials used for their preparation. Compounds 2 through 5 were dissolved as received in deionized water. Compound 1 was first prehydrolyzed, and then was diluted to the desired concentration in deionized water. Prehydrolysis of compound 1 was achieved by mixing it with ethanol and water at a weight ratio of 50/50/5, and by allowing the resulting 47.6% by weight solution to stand for 24 hours prior to use. The concentrations of compounds 2 through 5 and the prehydrolyzed version of compound 1 in deionized water are described in Table 2 (surface treatment solutions).

TABLE 1
Surface Treatment Compounds and Preparatory Materials

| | |
|---|---|
| 1. | Aminoethylaminopropyltrimethoxysilane [CAS# 107-15-3]; |
| | M.W. = 222 amu; Z6020 from Dow Corning |
| 2. | Urea [57-13-6]; M.W. = 60.06 amu; from Sigma |
| 3. | Acetic Acid, glacial, HPLC grade [64-19-7]; M.W. = 60 amu; |
| | from Fisher Scientific |
| 4. | Ammonium Hydroxide, reagent grade [1336-21-6]; M.W. = 35 amu; |
| | from Fisher Scientific |
| 5. | Sodium Hydroxide [1310-73-2]; M.W. = 40 amu; from Acros |
| | Chemicals |
| 6. | Deionized water, DIUF [7732-18-5]; M.W. = 18; from Fisher |
| | Scientific |
| 7. | Ethyl Alcohol, denatured, reagent [64-17-5]; from Aldrich |

TABLE 2
Surface Treatment Solutions - expressed as a percentage
by weight in deionized water

1. prehydrolyzed compound 1; 1%
2. compound 2; 2%
3. compound 3; 0.8%
4. compound 4; 1.05%
5. compound 5; 2%
6. no treatment

Each of the solutions in Table 2 was used to treat the inner surfaces of matched SYP wood block pairs (replicates of 6 pairs per solution). 0.3 g of each solution was applied with a soft nylon bristle brush to a single face of each block. The treated blocks were allowed to air-dry for 24 hours prior to use. After drying, 0.3 g of LINESTAR® 4605 adhesive was brushed onto a 2″×1¾″ section of a treated-face (only one block per pair was coated with adhesive). The adhesive-coated surface was then sandwiched with the second treated-block of the pair, so that the treated surfaces were in contact with the adhesive over a 2″×1¾″ contact area. This allowed ¼″ of each block to overhang in a “lap-shear” type geometry, similar to that described in ASTM D2559. The sandwiched specimens were then cured under pressure at room temperature, and were evaluated for shear strength (see methods as described in example 2). The average compressive shear strength of each sample set is given in Table 3.

TABLE 3
Compressive Shear Strength as a Function of Surface Treatment

| | Average Shear | Standard |
|---|---|---|
| Treatment Type | Strength (lbs.) | Deviation |
| 1. prehydrolyzed silane | 5300 | 400 |
| 2. urea | 5450 | 300 |
| 3. acetic acid | 5250 | 300 |
| 4. ammonium hydroxide | 5500 | 300 |
| 5. sodium hydroxide | 4700 | 400 |
| 6. no treatment | 4300 | 300 |

The data shows that several surface treatments can potentially be used to enhance the bond strength of one-part (one-component) moisture curable isocyanate adhesives with wood. Although not wishing to be bound by any theory, it appears that each of the chosen compounds has the capacity to react either nucleophilically and/or catalytically with an isocyanate compound. In addition, the prehydrolyzed silane compound has the ability to polymerize with itself through self condensation in the presence of water, which in other applications has been shown to enhance the bond strength between polymers and various substrates (organic and inorganic alike).

Interestingly, although the silane does improve the overall bond strength, the improvement is surprisingly no better than that achieved with simple monomeric urea, which unlike the silane, cannot undergo self-polymerization. Equally important, the effect of a surface treatment cannot be readily predicted by virtue of a compound's classification as a “base,” “acid,” “nucleophile,” or “electrophile.” For example, although sodium hydroxide, urea, and amino silane can each be classified as “basic,” only the amine-bearing urea and aminosilane compounds provide the improvement (sodium hydroxide provides little improvement). In contrast to sodium hydroxide, the amine-bearing ammonium hydroxide also provides an improvement on par with urea and aminosilane. Still, amine functionality alone is not a necessary criterion for improvement as can be appreciated by comparing bond strengths achieved with amine-bearing surface treatments to those achieved with the acetic acid surface treatment. In contrast to the amine-bearing compounds, acetic acid is “acidic” in character. Thus, acidity, basicity, and nucleophilicity alone are not adequate predictors of good surface treatment compounds for improving the bond strength of one-part moisture curable isocyanate adhesives to wood.

### Example 2

The next example illustrates that the improvement in bond strength is not monotonic with surface treatment concentration. Instead, there is a plateau beyond which no improvement is achieved. This sets the stage for Example 4, which surprisingly suggests that there may be an optimum urea concentration which (although not wishing to be bound to any theory) may arise not because of an improvement in bond strength but because of a concentration effect on open cure time of the adhesive.

The Effect of Surface Treatment Concentration on Shear Strength of Southern Yellow Pine

Wood Conditioning:

2″×2″×¾″ Southern Yellow Pine wood blocks were conditioned for 48 hours in a Form a Scientific Model 3940 “Reach In Incubator” set at 45% relative humidity at 38° C. The resulting wood moisture content was 8-9% as measured by a Wagner Model L606 handheld moisture meter.

Surface Treatment Solution Preparation:

200 g solutions of urea (Sigma 99.5% Urea CAS #57-13-6) in deionized water (Fisher Scientific DIUF CAS # 7732-18-5) solutions were prepared at concentrations of 0.05%, 1%, 5% and 10% by weight. The solutions were prepared by weighing the required amount of urea pellets into glass sample jars, and then by adding the deionized water until a total of 200 grams was reached. The samples were hand shaken until all of the urea pellets dissolved.

Block Shear Preparation and Testing:

Block shear samples were prepared in replicate sets of 6 using the urea in deionized water solutions at concentrations of 0.05%, 1%, 2%, 5%, and 10% along with a control of pure deionized water as surface treatments. Using a 1″ soft nylon bristle paint brush, 0.3 g of surface treatment solution was applied to each of the surfaces to be adhered. The surfaces were allowed to condition in ambient conditions for ten (10) minutes prior to the application of LINESTAR® 4605 adhesive. Using a 1″ soft nylon bristle paint brush, 0.23 grams of adhesive was applied to one surface of each pair of block assemblies. After applying the adhesive, each pair of blocks was assembled such that only 1¾″ of each block overlapped its pair along the grain direction, resulting in an adhered surface of 3.5 square inches. Once assembled, a set of 6 samples was placed in a Carver Model 2817 hydraulic laboratory press to cure at room temperature at a force adequate to provide a pressure of 250 lbs/in² for sixty (60) minutes. The assembly times for the block shear specimens ranged from approximately 3 minutes to 5 minutes. The geometry of each finished specimen was similar to that described in ASTM Standard D 2559-99. After 48 hours, the samples were tested for shear strength in compression using an MTS Alliance RF/100 Model 4501034 Universal Testing Machine and a shear test fixture. The compression loading was determined at a nominal cross head speed of 0.2 inches per minute. An electronic load cell and readout system was implemented for force measurement. The shear specimen's wood grain was tested parallel to the load direction.

| | Average Shear | Standard |
|---|---|---|
| Surface Treatment Solution | Strength (lb.) | Deviation |
| 10% Urea in Deionized Water | 7100 | 500 |
| 5% Urea in Deionized Water | 6200 | 1400 |
| 1% Urea in Deionized Water | 7500 | 1100 |
| 0.05% Urea in Deionized Water | 7000 | 1300 |
| 100% Deionized Water | 5100 | 400 |

The data shows that there is an upper limit in urea concentration beyond which no further improvement in bond strength is achieved. Also, water alone is not sufficient to provide an improvement in final bond strength. When the data from this example are compared to the data from Example 1, it is apparent that the shorter dry time (10 minutes in Example 2 vs. 24 hours in Example 1) results in higher overall bond strengths.

### Example 3

This Example illustrates the surprising discovery that improvements in bond strength can be achieved through a non-conventional use of surface treatments. Those skilled in the art of adhesion chemistry can appreciate that surface treatments or “primers” are most beneficial when they are applied to the substrate prior to the application of a coating or adhesive. In fact, Examples 1 and 2 demonstrate the use of such conventional methods for surface treatment application. However, as shown in Example 3, a non-conventional method is also apparently capable of providing an improvement in bond strength.

Effect of Application Method on Shear Strength

Wood Conditioning:

2″×2″×¾″ Southern Yellow Pine wood blocks were conditioned as described in Example 2.

Surface Treatment Preparation:

A solution of 10% by weight urea (Sigma 99.5% Urea CAS #57-13-6) in deionized water (Fisher Scientific DIUF CAS # 7732-18-5) was prepared as described in Example 2.

Block Shear Preparation and Testing:

Block shear samples were prepared by treating them with solutions of 10% by weight urea in deionized water. Three different application techniques were used:
1. Brush application of the solution directly onto the wood surfaces using a 1″ soft nylon bristle paint brush
2. Spray application of the solution directly onto the wood surface using a Preval power spray unit to atomize the urea in water solution
3. Spray application of the solution directly onto the applied adhesive using a Preval power spray unit to atomize the urea in water solution.

When the first two techniques were employed, samples were assembled as described in Example 2 (i.e., both wood surfaces were pre-treated prior to contacting them with the adhesive). However, in the case of technique 3, 0.23 grams of adhesive was applied to one surface of each pair of block assemblies prior to spraying 0.30 grams of surface treatment directly onto the adhesive. The samples were then assembled, pressed and tested as described in Example 2.

| | Bond | Standard |
|---|---|---|
| Application Method | Strength (lb.) | Deviation |
| Urea, Brush Applied to Wood Surfaces | 7100 | 500 |
| Urea, Spray Applied to Wood Surfaces | 7100 | 1600 |
| Urea, Spray Applied onto Adhesive | 6400 | 1700 |
| Water, Spray Applied onto Adhesive | 5100 | 400 |

The data suggests that an improvement in bond strength can be realized even when the treatment solution is applied directly to the uncured adhesive. Those skilled in the art can appreciate that surface treatments are generally not effective unless they are applied to the 2.0 substrate prior to the application of a coating or adhesive. This Example shows the surprising indication that a benefit from surface treatment can be achieved by direct topical application of a surface treatment solution to the adhesive (no pretreatment of wood). The improvement exceeds the bond strength achieved from the topical application of water alone.

### Example 4

This data shows that urea increases the rate of adhesive cure up to a concentration of about 5%. Higher concentrations actually decrease the cure rate in the bulk of the adhesive. Hence, there will likely be an optimum level for minimizing open time, and another optimum for increasing open time. Both possibilities could be desirable depending on the specific process needs.

Effect of Concentration on Adhesive Cure Rate and Open Time

Wood Conditioning:

Samples blocks of 2″×2″×¾″ Southern Yellow Pine wood were preconditioned by both oven drying and by humidity exposure. Oven drying was accomplished with a Fisher Scientific Isotemp Model 750F Oven set at 65° C. (samples were allowed to dry for a minimum of 24 hours). The final moisture content of the oven dried samples was less than 5% as measured with a Wagner Model L606 handheld moisture meter. Humidity conditioning was accomplished with a Form a Scientific Model 3940 Reach-In Incubator set at 38° C. and 45% relative humidity. Samples were allowed to equilibrate for a minimum of 48 hours, after which the wood moisture content of the samples was 8-9% as measured with a Wagner Model L606 handheld moisture meter.

Surface Treatment Preparation:

Solutions of 0.05%, 1%, 2%, 5% and 10% by weight urea in deionized water were prepared as described in Example 2.

Sample Preparation and Analysis for the Effect of Wood Moisture Content:

Using a 1″ soft nylon bristle paint brush, 0.30 grams of each surface treatment solution was applied to one 2″×2″ surface of each of the pre-conditioned wood blocks. In addition, a sample from both the oven drying and humidity exposure environments was treated with deionized water alone (containing no urea), and a second sample from each environment was left untreated (these samples served as controls). The treated surfaces were allowed to dry under ambient conditions for ten (10) minutes in one case, and for twenty (20) minutes in a second case. After the appropriate dry time, 0.55 g of LINESTAR® 4605 adhesive was applied to each treated surface with a soft nylon brush, and each block was visually observed to determine the onset of the adhesive's “cream time,” “string” or “gel time,” and “tack-free time.” The “cream time” in this study is defined as the time at which the majority of the surface of the 2″×2″ resin coated wood block is covered with entrapped carbon dioxide gas bubbles. The “string,” or “gel time” is defined as the time at which a spatula can be used to touch the adhesive surface, and tacky “strings” are observed as the spatula is pulled away. The “tack-free” time is defined as the time at which a spatula can be lightly pressed against the surface of the curing adhesive, and the surface remains intact (no “strings”) upon removal of the spatula.

Adhesive Cure on Oven Dried Wood - Surface
Treatment Drying Time: 10 min.

| | Wood | Start | Cream | Gel | Tack-Free |
|---|---|---|---|---|---|
| | Moisture | Time | Time | Time | Time |
| Sample ID | Content | (min) | (min) | (min) | (min) |
| No Treatment | <5% | 0 | N/A | 14:35 | 25:44 |
| Deionized Water | <5% | 0 | 1:24 | 4:48 | 17:12 |
| 0.05% Urea/DI H₂0 | <5% | 0 | 1:17 | 4:03 | 16:40 |
| 1.0% Urea/DI H₂0 | <5% | 0 | 1:23 | 3:55 | 15:57 |
| 2.0% Urea/DI H₂0 | <5% | 0 | 2:13 | 3:13 | 17:24 |
| 5.0% Urea/DI H₂0 | <5% | 0 | 2:29 | 5:01 | 23:01 |
| 10.0% Urea/DI H₂0 | <5% | 0 | 2:23 | 4:52 | 22:18 |

Adhesive Cure on Humidity Conditioned Wood - Surface
Treatment Drying Time: 10 min.

| | Wood | Start | Cream | Gel | Tack-Free |
|---|---|---|---|---|---|
| | Moisture | Time | Time | Time | Time |
| Sample ID | Content | (min) | (min) | (min) | (min) |
| No Treatment | 8-9% | 0 | N/A | 6:55 | 17:38 |
| Deionized Water | 8-9% | 0 | 0:57 | 3:10 | 11:30 |
| 0.05% Urea/DI H₂0 | 8-9% | 0 | 0:49 | 4:58 | 11:08 |
| 1.0% Urea/DI H₂0 | 8-9% | 0 | 0:32 | 4:21 | 9:46 |
| 2.0% Urea/DI H₂0 | 8-9% | 0 | 0:36 | 4:14 | 8:41 |
| 5.0% Urea/DI H₂0 | 8-9% | 0 | 0:52 | 4:13 | 9:18 |
| 10.0% Urea/DI H₂0 | 8-9% | 0 | 0:38 | 4:14 | 9:57 |

Although the overall cure rates for the oven dried wood samples are slower than analogously humidity conditioned samples, the trends are nevertheless the same. Namely, non-treated samples are the slowest to cure, and both the deionized water treated and the urea treated samples are the fastest to cure. Although deionized water alone increases the cure rate, the addition of urea provides a further increase up to a concentration of about 1% to 5%, beyond which the rate is observed to slightly diminish—independent of the wood pre-conditioning method. This surprising trend shows that there exists a preferred level of urea surface treatment for enhancing the cure rate (1 to 5%), and a preferred level for diminishing the cure rate (>5%), both of which can be accomplished with a simultaneous increase in bond strength as reported in Example 2.

In examining the oven dried (<5% moisture content), the progression of cure in the non-treated sample differs from that of the other samples. Specifically, the non-treated sample cures predominantly near the air-resin interface. As a result, a thin skin of cured adhesive is formed, and no cream time is observed. Although a tack-free surface is eventually formed as a result of surface skinning, the bulk of the adhesive remains uncured below the skinned surface.

Examination of the humidity conditioned wood samples (8-9% moisture content) show that the non-treated sample also exhibits a different cure progression than the other samples. Some signs of creaming are observed, but only in random spots across the 2″×2″ surface. The string and tack free times are shorter than those seen with the oven dried wood. However, as in the oven-dried wood case, uncured adhesive is also observed beneath the cured adhesive/air interface.

Hence, independent of the wood conditioning method, an adhesive on untreated wood does not cure as well as the same adhesive on surface treated wood. In the non-treated samples, the surface of the adhesive “skins over” and leaves the bulk of the adhesive uncured. Surface treatment of the wood (with either water alone or with urea and water) enhances the cure rate. Also, low levels of urea are more effective at reducing cure time than de-ionized water alone.

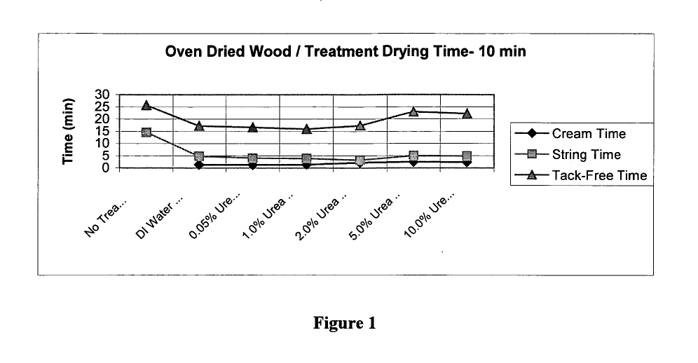

As shown graphically in FIG. 1 (relative cure time on oven dried wood as a function of urea surface treatment), surface treatment with a 1 to 5% concentration of urea by weight in water provides an enhancement in cure rate. When combined with the data from Example 2, this concentration range also coincides with an increase in final bond strength. Beyond this concentration, the cure rate is observed to decrease, but the bond strength is not affected (Example 2).

[image]

In addition to the above data, the table below shows that the same relative trends are also observed at longer “dry times” (the dry-time is the time allowed for surface treatment drying prior to the adhesive application). In this case, the surface treatment was applied to oven-dried wood, and its drying time was doubled to 20 minutes. Again, the results show that low levels of urea, between 1 and 5% by weight, enhance the cure rate of isocyanate adhesives. Higher levels actually slow the cure rate.

Adhesive Cure on Oven Dried Wood—Surface Treatment Drying Time: 20 min.

Adhesive Cure on Oven Dried Wood - Surface Treatment Drying Time:
20 min.

| | Wood | Start | Cream | Gel | Tack-Free |
|---|---|---|---|---|---|
| | Moisture | Time | Time | Time | Time |
| Sample ID | Content | (min) | (min) | (min) | (min) |
| No Treatment | <5% | 0 | N/A | 8:00 | 20:42 |
| Deionized Water | <5% | 0 | 2:09 | 4:59 | 14:55 |
| 0.05% Urea/DI H₂0 | <5% | 0 | 2:57 | 4:02 | 13:57 |
| 1.0% Urea/DI H₂0 | <5% | 0 | 1:36 | 4:24 | 15:02 |
| 2.0% Urea/DI H₂0 | <5% | 0 | 1:18 | 3:44 | 15:27 |
| 5.0% Urea/DI H₂0 | <5% | 0 | 2:10 | 4:30 | 19:08 |
| 10.0% Urea/DI H₂0 | <5% | 0 | 2:05 | 4:24 | 18:35 |

### Example 5

Effect of Vehicle on Surface Treatment Effectiveness

The purpose of this example is to show the effect of vehicle (solvent) on surface treatment efficiency. Surprisingly, the choice of vehicle can have a dramatic influence on the effectiveness of a surface treatment, which shows that one of the claims to invention is a combination of both vehicle and surface treatment, where the preferred vehicle is water for the case of a urea surface treatment. Permutations in this example include no treatment, solvent alone (1-propanol), solvent with urea, water alone, and water with urea at the same concentration as in the solvent case. Open cure time will be compared as well as final bond strength.

Wood Conditioning:

Paired sample blocks of Southern Yellow Pine wood were pre-conditioned in an oven as described in Example 4 (for open cure time studies). Southern Yellow Pine wood block pairs were also conditioned in a humidity chamber as described in Example 4 (for bond strength studies).

Surface Treatment Solution Preparation:

50 gram solutions of urea (Sigma 99.5% Urea CAS # 57-13-6) in 1 Propanol (CAS #71-23-8) were prepared at concentrations of 1% and 2% by weight. The solutions were prepared by weighing the required amount of urea pellets into sample jars, and then by adding the 1-propanol until a total of 50 grams was reached. The samples were mixed using an ultra sonic mixer until all of the pellets dissolved. Analogous solutions were also prepared with deionized water as the vehicle. These treatments were used to determine the relative effect of vehicle on cure rate, and the relative effect of vehicle on bond strength as described below.

Sample Preparation and Analysis for the Effect of Vehicle on Cure:

Using a soft nylon brush, 0.30 grams of each surface treatment solution was applied to separate 2″×2″ pre-conditioned wood blocks. In addition, one pre-conditioned wood block was treated with deionized water, another was treated with 1-propanol, and yet another was left untreated. The treated surfaces were allowed to dry under ambient conditions for ten (10) minutes prior to the brush application of 0.55 grams LINESTAR® 4605 adhesive. Each block was observed to determine the onset of cream time, string or gel time, and tack-free time, as defined in Example 4.

Effect of vehicle on open cure time. Substrate: Humidity conditioned
wood. Surface Treatment Drying Time: 10 min

| | Wood | Start | Cream | Gel | Tack-Free |
|---|---|---|---|---|---|
| | Moisture | Time | Time | Time | Time |
| Sample ID | Content | (min) | (min) | (min) | (min) |
| No Treatment | <8-9% | 0 | N/A | 6:55 | 17:38 |
| Deionized Water | <8-9% | 0 | 0:46 | 2:34 | 9:02 |
| 1-Propanol | <8-9% | 0 | 1:38 | 5:39 | 14:42 |
| 1.0% Urea/1-Propanol | <8-9% | 0 | 2:12 | 5:52 | 13:30 |
| 2.0% Urea/1-Propanol | <8-9% | 0 | 2:22 | 5:42 | 14:09 |

As shown in the above table, 1-propanol alone provides an increase in cure rate, but the increase is not as pronounced as with water alone. Surprisingly, the addition of urea to the 1-propanol further prolongs the cure time. This effect is opposite to the increase in cure rate that is observed when urea is added to water (as shown in Example 4). This shows that the choice of vehicle is important, and that certain combinations of vehicles and surface treatments can synergistically enhance the cure rate (urea in water is an example of such a synergy).

Effect of Vehicle on Shear Strength

Block Shear Preparation and Testing:

The wood for this experiment was oven dried (moisture content <5%). Block shear samples were prepared in replicate sets of 6 with permutations including; no treatment, water alone, 1-propanol alone, and urea in both water and 1-propanol at 1% and 2% by weight. The procedures for surface treatment application, adhesive application, assembly, pressing, and testing were performed as described in Example 2.

Shear Strength in Compression of Adhered Blocks, Prepared with Surface Treated, Oven Dried Wood.

| Surface Treatment | Average Shear | Standard |
|---|---|---|
| Solution | Strength (lb.) | Deviation |
| No Treatment | 300 | 300 |
| Deionized Water | 4500 | 600 |
| 1-Propanol | 2500 | 1500 |
| 1% Urea in Deionized Water | 6100 | 600 |
| 2% Urea in Deionized Water | 5000 | 1800 |
| 1% Urea in 1-Propanol | 2100 | 900 |
| 2% Urea in 1-Propanol | 1300 | 1000 |

The results of this experiment show that choice of vehicle has a tremendous effect on the bond strength. Interestingly, both water and 1-propanol alone can improve the bond strength (water more so than 1-propanol), but when urea is added to 1-propanol, the bond strength is surprisingly diminished, whereas the bond strength is increased when urea is analogously added to water. Thus, there exists a preferred vehicle for urea, of which one example is water.

### Example 6

LINESTAR® 4675 adhesive (a “non-skinning” soy/clay containing formula) was laminated with SYP for shear strength measurements as described in the previous examples. The wood blocks were treated with 0.3 g 1% prehydrolyzed silane (described in Example 1, and herein referred to as “Z6020P”). Treated and untreated blocks were allowed to set in the open atmosphere for two hours prior to application of the adhesive (0.3 g). Comparative samples were also made using LINESTAR® 4605 adhesive. The table below provides the average strengths and percent wood failures (average of six samples in each case).

| | Surface | % wood | Block shear |
|---|---|---|---|
| Sample | treatment | failure | strength(lbs.) |
| 83-1, LINESTAR ® 4605 | None | 60 | 4200 |
| 83-2, LINESTAR ® 4605 | 1% Z6020P | 85 | 6000 |
| 83-3, LINESTAR ® 4675 | None | 60 | 4600 |
| 83-4, LINESTAR ® 4675 | 1% Z6020P | 85 | 5700 |

Under the experimental conditions of this example, surface treatment provides an improvement in the percentage of wood failure and in the block shear strength for both types of adhesives.

### Example 7

This Example shows a wood laminate construction comprising at least two wood members adhered together with one-part isocyanate based adhesive, wherein said adhesive is applied either as a liquid, as a paste, or as a molten solid; and where said adhesive is sufficiently cured via a moisture activated cure mechanism to yield either an adhered wood composite, a laminate, or a combination thereof; wherein said construction has properties sufficient so as to pass the requirements for “Resistance to Shear by Compression Loading” as described in section 14 of ASTM Specification D 2559-00.

The wood for this example included planed Southern Yellow Pine, and planed Douglas Fir. Sample preparation methods, wood conditioning criteria, and block shear testing methods were identical to those described in Example 2 (these methods were similar to those described in ASTM D2559-00). The methods used for lamination were also the same as those given in Example 2, where six samples were pressed at one time for subsequent averaging of results. In each case, 0.3 g of the adhesive was applied to one surface of a single block taken from each pair of block assemblies using a 1″ soft nylon bristle brush as previously described. In cases where surface treatments were employed, approximately 0.3 g of the treatment solution was applied to each of the surfaces to be adhered. Additional surface treatments for this example include 1% PVA in water (ELVANOL® 75-15 surface treatment from Du Pont), and 1% AIRFLEX® 426 surface treatment in water (carboxylated poly(ethylene-co-vinyl acetate) copolymer from Air Products, 63% solids in water emulsion). All samples were allowed to condition for at least 18 hours prior to lamination in the aforementioned humidity control chamber (45% relative humidity, 38° C., final wood moisture content of 8-9%). The resultant shear strength values (force to failure) were averaged and converted to pounds per square inch (psi) by accounting for the surface area at the adhered interface (3.5 square inches). In addition, the average percentage of visual wood failure was reported for each group. The Table A below provides the materials that were used for this example, while Table B provides the results of block shear tests for each group.

TABLE A
Adhesives and Surface treatments for Example 7 Samples.

| Sample | Adhesive | Wood Type | Surface Treatment |
|---|---|---|---|
| 1 (126-1) | LINESTAR ® 4605 adhesive | SYP | none |
| 2 (126-2) | LINESTAR ® 4605 adhesive | SYP | 1% Z6020P |
| 3 (7604-46) | LINESTAR ® 4800 adhesive | SYP | none |
| 4 (206-2) | LINESTAR ® 4800 adhesive | SYP | 1% PVA |
| 5 (7604-48) | LINESTAR ® 4800 adhesive | SYP | 1% Z6020P |
| 6 (157-13B) | LINESTAR ® 4800 adhesive | SYP | 1% urea |
| 7 (239-A) | LINESTAR ® 4800 adhesive | DF | none |
| 8 (198-7) | LINESTAR ® 4800 adhesive | DF | 1% urea |
| 9 (209-25) | LINESTAR ® 4800 adhesive | DF | 1% Z6020P |
| 10 (209-2) | LINESTAR ® 4800 adhesive | DF | 1% PVA |
| 11 (239-C) | LINESTAR ® 4800 adhesive | DF | 1% AIRFLEX ® 426 |
| | | | product/with 0.5% |
| | | | dodecylbenzene-sulfonic |
| | | | acid sodium salt |
| 12 (239-E) | LINESTAR ® 4800 adhesive | DF | 1% AIRFLEX ® 426 product |
| 13 (238-H) | LINESTAR ® 4800 adhesive | SYP | 1% AIRFLEX ® 426 |
| | | | product/with 0.5% |
| | | | dodecylbenzene-sulfonic |
| | | | acid sodium salt |

TABLE B
Average Block Shear Strengths (psi) and Percentage of Wood Failure
for Example 7 Samples.

| Sample | Shear Strength (psi) | % Wood Failure |
|---|---|---|
| 1 | 1314 | 85 |
| 2 | 1830 | 100 |
| 3 | 1306 | 50 |
| 4 | 1542 | 88 |
| 5 | 1650 | 78 |
| 6 | 1742 | 95 |
| 7 | 1200 | 38 |
| 8 | 1191 | 50 |
| 9 | 1624 | 50 |
| 10 | 1807 | 75 |
| 11 | 1657 | 95 |
| 12 | 1571 | 97 |
| 13 | 1085 | 84% |

The minimum requirements for passing the “Resistance to Shear by Compression Loading” are given in Table 1 of ASTM D2559-00. Douglas Fir and Southern Yellow Pine with 8% moisture contents must have minimum strength requirements of 1180 psi and 1440 psi respectively. In addition, the percentage of wood failure must be not less than 75% (per section 14.4.2). Based on the results provided above, several types of samples pass both requirements of the test. However, in the absence of a surface treatment, the samples fail to meet the strength requirement, the wood failure requirement, or both. Surprisingly, the urea surface treatment does not improve the bond strength for DF as it does for SYP. Similarly, the AIRFLEX® 426 surface treatment with surfactant does not improve the bond strength for SYP as it does for DF. Thus, there is no obvious and predictable choice of surface treatment for any given type of wood. Instead, there will be preferred surface treatments for SYP (urea, PVA, and Z6020 being three examples), and preferred treatments for DF (AIRFLEX® 426 ethylene-co-vinyl acetate-co-acrylic acid terpolymer; and PVA being two examples).

### Example 8

This Example shows a wood laminate construction comprising at least two wood members adhered together with one-part isocyanate based adhesive, wherein said adhesive is applied either as a liquid, as a paste, or as a molten solid, and where said adhesive is sufficiently cured via a moisture activated cure mechanism to yield either an adhered wood composite, a laminate, or a combination thereof; wherein said construction has properties sufficient so as to pass the requirements for “Resistance to Shear by Compression Loading” as described in section 14 of ASTM Specification D 2559-00.

The wood for this example included Southern Yellow Pine, and Douglas Fir. Procedures were identical to those described in Example 7, except the surface of the wood blocks were sanded prior to treatment and lamination (these methods were similar to those described in ASTM D2559-00). Table C provides the materials that were used for this example, while Table D provides the results of block shear tests for each group.

TABLE C
Adhesives and Surface treatments for Example 8 Samples.

| | | Wood | |
|---|---|---|---|
| Sample | Adhesive | Type | Surface Treatment |
| 1 (238-B) | LINESTAR ® 4800 | SYP | none |
| | adhesive | | |
| 2 (238-D) | LINESTAR ® 4800 | SYP | 1% urea |
| | adhesive | | |
| 3 (239-B) | LINESTAR ® 4800 | DF | none |
| | adhesive | | |
| 4 (239-D) | LINESTAR ® 4800 | DF | 1% AIRFLEX ® 426 product |
| | adhesive | | with 0.5% dodecylbenzene- |
| | | | sulfonic acid sodium salt |
| 5 (239-F) | LINESTAR ® 4800 | DF | 1% AIRFLEX ® 426 product |
| | adhesive | | |
| 6 (239-G) | LINESTAR ® 4800 | DF | 1% PVA |
| | adhesive | | |

TABLE D
Average Block Shear Strengths (psi) and Percentage of Wood Failure for
Example 8 Samples.

| Sample | Shear Strength (psi) | % Wood Failure |
|---|---|---|
| 1 | 1171 | 78 |
| 2 | 1714 | 98 |
| 3 | 1057 | 47 |
| 4 | 1457 | 95 |
| 5 | 2028 | 90 |
| 6 | 1657 | 83 |

The minimum requirements for passing the “Resistance to Shear by Compression Loading” are given in Table 1 of ASTM D2559-00. Douglas Fir and Southern Yellow Pine with 8% moisture contents must have minimum strength requirements of 1180 psi and 1440 psi respectively. In addition, the percentage of wood failure must be not less than 75% (per section 14.4.2). Again, based on the results provided above, several types of samples pass both requirements of the test. However, in the absence of a surface treatment, the samples fail to meet either the strength requirement, the wood failure requirement, or both.

### Example 9

This Example shows a wood laminate construction comprising at least two wood members adhered together with a one-part isocyanate based adhesive, wherein said adhesive is applied either as a liquid, as a paste, or as a molten solid; and where said adhesive is sufficiently cured via a moisture activated cure mechanism to yield either an adhered wood composite, a laminate, or a combination thereof; wherein said construction has properties sufficient so as to pass the requirements for “Resistance to Delamination During Accelerated Exposure” as described in section 15 of ASTM Specification D 2559-00.

The wood in this example was planed Southern Yellow Pine. Six plies for each billet (6″×12″× 3/4″) were conditioned at 45% RH, 38° C. for 24 hours to provide a moisture content of 8-9%. For cases involving surface treatments, approximately 5 g of the particular treatment solution was applied to each surface prior to the conditioning period (using a 1″ soft nylon bristle paintbrush).

Approximately 7 g of adhesive was spread at each interface to be bonded (on one surface per interface) using a 4″ wide spatula, and a 1″ soft nylon bristle paint brush. After applying the adhesive, the 6-ply billets were stacked, and were then placed in a Carver Model 2817 hydraulic laboratory press to cure at room temperature at a force adequate to provide a pressure of 250 lbs/in² for sixty (60) minutes. The assembly times ranged from approximately 4 minutes to 5 minutes. The cured billets were allowed to set under ambient conditions for at least 48 hours prior to preparing them for testing.

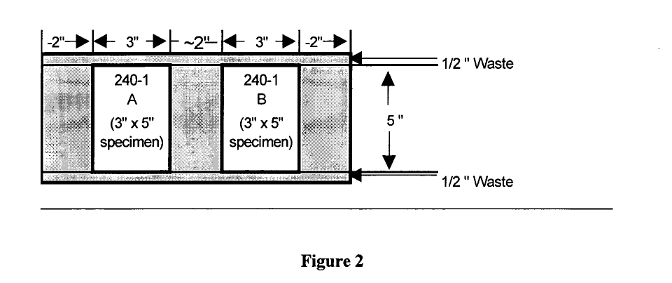

Each billet was cut as shown in FIG. 2 [the diagram below] (the areas highlighted in gray were discarded). Note that these methods for sample preparation were similar to those described in ASTM D2559-00, while the testing procedures were the same. In most cases, two specimens from each billet were tested according to the procedures outlined in “Resistance to Delamination During Accelerated Exposure” as described in section 15 of ASTM Specification D 2559-00.

[image]

Adhesives for this example included LINESTAR® 4605 adhesive, LINESTAR® 4605 adhesive modified to contain 16.67% by weight CAPA® 6501 diol (polycaprolactone diol, Mn 50,000, from Solvay); and LINESTAR® 4605 adhesive modified to contain 8.3% by weight CAPA® 6501 diol, and 8.3% by weight of surface treated polyethylene powder (“PE” from Aldrich, catalog number 43,427-2, from the Aldrich catalog for 2000-2001).

Adhesives containing CAPA® 6501 diol were prepared by dispersing the powdered polycaprolactone into the base adhesives at room temperature under a nitrogen blanket, and by then heating the dispersions in a forced air oven set at 65° C. (above the melt temperature for the CAPA® 6501 diol) for a minimum of four hours in sealed containers (with intermittent mixing). Upon removal from the oven, the resultant adhesives were clear and amber in color. Upon cooling, recrystallization of the polycaprolactone mid-blocks resulted in increased opacity and viscosity, where the cooled adhesive had paste-like to solid-like consistency, depending on the CAPA® 6501 diol level. The CAPA® 6501 diol modified adhesives in this example were re-melted (to a clear amber state) prior to their application. It should be noted that these adhesives could be applied in their “paste-like” form at room temperature to yield similar results.

Adhesives containing PE were similarly prepared by dispersing the powdered polyethylene into the adhesives under a nitrogen blanket. In the absence of CAPA® 6501 diol, the PE could be dispersed at room temperature. However, when combined with CAPA® 6501, the CAPA® 6501 diol prepolymer was first prepared as described above, and then PE was dispersed in the homogenous molten form of the “hot-melt” under a nitrogen blanket. The adhesive was then allowed to cool to room temperature to yield a recrystallized “paste” comprised of re-crystallized CAPA® 6501 diol, partially soluble CAPA® 6501 diol, and dispersed PE. This adhesive was later re-molten (to a clear amber state) prior to application.

The adhesives and surface treatments for the billets are summarized in Table E, while Table F provides a summary of the percent delamination for each specimen (averaged across all interfaces). In addition, Table G provides the breakdown of the average percent delamination for each interface in all of the 6-ply specimens.

TABLE E
Adhesives and Surface Treatments for Example 9.

| | | Surface |
|---|---|---|
| Sample | Adhesive | Treatment |
| 1 (7604-154-1) | LINESTAR ® 4605 adhesive | none |
| 2 (7604-154-2) | LINESTAR ® 4605 adhesive | 1% Z6020P |
| 3 (7604-154-3) | LINESTAR ® 4605 adhesive | 1% urea |
| 4 (7604-154-6) | LINESTAR ® 4605 adhesive + | 1% Z6020P |
| | 16.67% CAPA ® 6501 diol | |
| 5 (7604-154-5) | LINESTAR ® 4605 adhesive + | 1% Z6020P |
| | 8.3% CAPA ® 6501 diol + 8.3% PE | |

TABLE F
Average delamination for the two specimens from each 6-ply billet.

| Sample | % Delamination |
|---|---|
| 1 | 20.6, 21.1 |
| 2 | 6.7, 2.5 |
| 3 | 4.6, 6.4 |
| 4 | 0.2, 0.2 |
| 5 | 0.0, 0.6 |

TABLE G
Percent delaminations for each interface
(two specimens from each 6-ply billet).

| Sample | Interface 1 | Interface 2 | Interface 3 | Interface 4 | Interface 5 |
|---|---|---|---|---|---|
| 1 | 13.5, 10.5 | 35.6, 32.0 | 30.5, 40.6 | 19.7, 8.3 | 3.8, 14.0 |
| 2 | 9.0, 4.9 | 18.0, 4.2 | 5.3, 2.2 | 0.0, 1.1 | 1.1, 0.0 |
| 3 | 3.0, 4.2 | 5.3, 10.6 | 1.9, 1.1 | 10.5, 11.7 | 2.2, 4.5 |
| 4 | 0.0, 0.0 | 1.0, 0.0 | 0.0, 0.0 | 0.0, 0.0 | 0.0, 1.0 |
| 5 | 0.0, 1.5 | 0.0, 1.5 | 0.0, 0.0 | 0.0, 0.0 | 0.0, 0.0 |

The minimum requirements for passing the “Resistance to Delamination During Accelerated Exposure” test are given in Table 2 (section 15) of ASTM Specification D 2559-00. Softwoods like Douglas Fir and Southern Yellow Pine must exhibit less than 5% delamination (overall) with no more than 1% delamination in any bondline. The results above show that surface treatments and high molecular weight reinforcing polymers can improve the performance of these adhesives when tested under wet conditions.

### Example 10

This Example shows a wood laminate construction comprising at least two wood members adhered together with a one-part isocyanate based adhesive, wherein said adhesive is applied either as a liquid, as a paste, or as a molten solid; and where said adhesive is sufficiently cured via a moisture activated cure mechanism to yield either an adhered wood composite, a laminate, or a combination thereof, wherein said construction has properties sufficient so as to pass the requirements for “Resistance to Delamination During Accelerated Exposure” as described in section 15 of ASTM Specification D 2559-00.

The wood in this example was sanded Douglas Fir. Six plies for each billet (6″×12″×¾″) were conditioned at 45% RH, 38° C. for 24 hours to provide a moisture content of 8-9%. For cases involving surface treatments, approximately 5 g of the particular treatment solution was applied to each interface prior to the conditioning period (using a 1″ soft nylon bristle paintbrush).

Approximately 7 g of adhesive was spread at each interface to be bonded (on one surface per interface) using a 4″ wide spatula, and a 1″ soft nylon bristle paint brush. After applying the adhesive, the 6-ply billets were stacked, and were then placed in a Carver Model 2817 hydraulic laboratory press to cure at room temperature at a force adequate to provide a pressure of 250 lbs/in² for sixty (60) minutes. The assembly times ranged from approximately 4 minutes to 5 minutes. The cured billets were allowed to set under ambient conditions for at least 48 hours prior to preparing them for testing.

Testing procedures were the same as those outlined in Example 9. The adhesive for this example was LINESTAR® 4800 adhesive.

The adhesive and surface treatment for the billets are summarized in Table H, while Table I provides a summary of the percent delamination for each specimen (averaged across all interfaces). In addition, Table J provides the breakdown of the average percent delamination for each interface in the 6-ply specimens.

TABLE H
Adhesive and Surface Treatment for Example 10

| Sample | Adhesive | Surface Treatment |
|---|---|---|
| 1 (7604-240-1B) | LINESTAR ® | none |
| | 4800 adhesive | |
| 2 (7604-240-5B) | LINESTAR ® | 1.5% AIRFLEX ® 426 |
| | 4800 adhesive | with 0.125% |
| | | dodecylbenzene-sulfonic |
| | | acid sodium salt |

TABLE I
Average delamination for the two specimens from each 6-ply billet.

| Sample | % Delamination |
|---|---|
| 1 | 12.9 |
| 2 | 0 |

TABLE J
Percent delaminations for each interface (two
specimens from each 6-ply billet).

| Sample | Interface 1 | Interface 2 | Interface 3 | Interface 4 | Interface 5 |
|---|---|---|---|---|---|
| 1 | 20.4 | 17.0 | 5.7 | 5.7 | 16.0 |
| 2 | 0.0 | 0.0 | 0.0 | 0.0 | 0.0 |

The minimum requirements for passing the “Resistance to Delamination During Accelerated Exposure” test are given in Table 2 (section 15) of ASTM Specification D 2559-00. Softwoods like Douglas Fir and Southern Yellow Pine must exhibit less than 5% delamination (overall) with no more than 1% delamination in any bondline. The results above show that the LINESTAR® 4800 can be used to produce Douglas Fir laminates with the capacity to pass the D2559 wet delamination test.

### Example 11

This examples shows the comparison of different methods of wood surface preparation. The example illustrates that the way the surface is prepared, either by planning the wood or sanding the wood, has an effect on the “Resistance to Delamination During Accelerated Exposure” of ASTM Specification D 2559-00.

A series of Southern Yellow Pine boards were “freshly surfaced” by planing to a nominal thickness of 0.75 inches in accordance with the ASTM D2559-00 specification using a Delta Planner, Model 22-540. A second series of boards were sanded to a nominal thickness of 0.75 inches using Rand-Bright Corporation sander, Model S24X60, and Kingspor CS311-P60 grit sandpaper.

A surface treatment of 1% urea by weight in deionized water was applied to the surface of the planed and sanded wood with a natural bristle brush. The surface treated wood samples were placed in an environmental chamber for conditioning to achieve a moisture content of 8-9%, as described in Example 9. The wood samples were assembled as described in Example 9. The adhesive for this example was LINESTAR® 4800 adhesive.

After applying the adhesive to one surface of the two interfaces in a three ply billet, it was placed in a Carver press, as described in Example 9, and pressed at a pressure of 250 lbs/in² for thirty five (35) minutes at a press platen temperature of 121° C. (250° F.). This process was repeated with another three ply billet. The three-ply billets were than returned to the environmental chamber for reconditioning. After reconditioning to a moisture content of 8-9% the surfaces of the pressed billets were sanded and two, three-ply billets were adhered together with LINESTAR® 4605 adhesive by coating one surface of the interface with adhesive (approximately 6 to 8 grams) and pressing in a Carver press at a pressure of 250 lbs/in² for sixty (60) minutes at ambient press platen temperature. This procedure was performed on planed and sanded wood for the purpose of comparing the effect of wood surface preparation. The result of ASTM, D-2559-00 testing can be seen in the table below.

average Delamination for the Two Specimens from Each 6-Ply Billet.

| Sample | % Delamination |
|---|---|
| 1. LINESTAR ® 4800 adhesive, | 12.3, 17.2 |
| Planed Wood, Pressed 121° C./35 Minutes | |
| 2. LINESTAR ® 4800, Sanded Wood, | 4.8, 5.7 |
| Pressed 121° C./35 Minutes | |

Percent delaminations for each interface (two
specimens from each 6-ply billet)

| Sample | Interface 1 | Interface 2 | Interface 3 | Interface 4 | Interface 5 |
|---|---|---|---|---|---|
| 1 | 3.1, 4.9 | 19.5, 19.1 | 1.5, 0.0 | 32.7, 53.2 | 4.9, 8.7 |
| 2 | 4.1, 1.5 | 4.9, 6.8 | 6.0, 9.4 | 9.1, 10.6 | 0.0, 0.0 |

This data illustrates the effect of wood surface preparation on the resistance to wet delamination per ASTM D2559-00.

### Example 12

Sample billets were prepared on a larger scale for this example (in accordance with D2559 procedures), and were pressed in a large press at room temperature for 4 hours. The adhesives included LINESTAR® 4605 adhesive and LINESTAR® 4800 adhesive with and without a 1% urea in deionized water surface treatment. The wood was sanded SYP (per procedures outlined in example 11).

Wood Preparation:

5/4″ thick flat grained southern yellow pine was “freshly surfaced” by sanding (via procedures outlined in example 11) to 0.75″ nominal. The wood was then cut into boards that were 5.5″ in width and 24″ in length. The boards were measured for their physical characteristics, including length, width, thickness and weight, for calculation of specific gravity. The boards were sorted into six layer billets according to specific gravity. The billets were assembled in a manner such that the highest specific gravity boards were in the center and the lowest specific gravity boards comprised the outer layer. The boards were placed in an environmental chamber overnight (16 to 20 hours) set at a relative humidity of 45% and a temperature of 38° C. to provide a wood moisture content of 8-9%. In all cases, the boards were used to prepare laminated billets within 24 hours of sanding.

Assembly of Controls

Two control billets were assembled, one using LINESTAR® 4605 adhesive and one using LINESTAR® 4800 adhesive. All samples were pressed for 240 minutes at room temperature under a pressure of 250 psi.

LINESTAR® 4605 adhesive: the adhesive was applied using a ¼″ nap paint roller to each surface of the wood board. (The outer layers received adhesive on one surface.) The resin dosage per glue line was 30#/msf with 15#/msf added to each wood surface. Each adhesive coated surface was sprayed with 1.5#/msf of de-ionized water. The billet was assembled and placed into the 350-Ton Layton Press. After a total assembly time of 5.5 minutes, 250 psi of pressure was applied to the billet. Total press residence time was 240 minutes at room temperature.

LINESTAR® 4800 adhesive: the lay-up for this control was the same as for the LINESTAR® 4605 described above with the exception of the assembly time. The total assembly time for this adhesive was 10 minutes.

Assembly of Experimental (Surface Treated Wood)

Two experimental billets were assembled, one using LINESTAR® 4605 and one using LINESTAR® 4800, and both treated with RUBINOL® ST010 surface treatment (1% urea in water). All samples were pressed for 240 minutes at room temperature under a pressure of 250 psi.

LINESTAR® 4605 adhesive: both surfaces of all of the boards were treated with RUBINOL® ST010 in an evenly distributed coating and the boards allowed to dry for one hour prior to adhesive application. The billets were then assembled as described for the LINESTAR® 4605 controls above.

LINESTAR® 4800 adhesive: the boards were surface treated as described for the LINESTAR® 4605 above. The billets were assembled as described for the LINESTAR® 4800 controls above.

Testing

The billets were cut and tested in accordance with D2559 standards by PFS Corporation of Madison, Wis. A total of six blocks were cut and tested from each billet. Although the billets were larger, the size of the blocks was the same as that reported in example 9. The percentage of bondline delamination for each billet was reported as the average delamination from the six blocks. Results are given in Tables K and L.

TABLE K
Average % delamination for the six specimens
from each 6-ply billet of Example 12.

| Sample | % Delamination |
|---|---|
| 1 - LINESTAR ® 4605 | 0.46 |
| 2 - LINESTAR ® 4605 with 1% urea | 0.00 |
| 3 - LINESTAR ® 4800 | 0.56 |
| 4 - LINESTAR ® 4800 with 1% urea | 0.13 |

TABLE L
Average % delamination for each interface
(six specimens from each 6-ply billet).

| Sample | Interface 1 | Interface 2 | Interface 3 | Interface 4 | Interface 5 |
|---|---|---|---|---|---|
| 1 | 0.00 | 0.20 | 0.00 | 0.26 | 0.00 |
| 2 | 0.00 | 0.00 | 0.00 | 0.00 | 0.00 |
| 3 | 0.09 | 0.24 | 0.00 | 0.22 | 0.00 |
| 4 | 0.00 | 0.00 | 0.00 | 0.13 | 0.00 |

The minimum requirements for passing the “Resistance to Delamination During Accelerated Exposure” test are given in Table 2 (section 15) of ASTM Specification D 2559-00. Softwoods like Southern Yellow Pine must exhibit less than 5% delamination (overall) with no more than 1% delamination in any bondline. The results above show that the LINESTAR® 4605 adhesive and LINESTAR® 4800 adhesive can be used to produce SYP laminates that pass the D2559 wet delamination test both with and without urea surface treatment. Furthermore, the frequency of delaminates is significantly reduced when a urea surface treatment is used.

### Example 13

This example demonstrates the effect of wood surface preparation and surface treatment on the D2559-00 wet delamination performance of Douglas Fir. All procedures in this example were identical to those reported in Example 10 with one difference: the Douglas Fir was planed instead of sanded.

The adhesive and surface treatments for the billets are summarized in Table M, while Table N provides a summary of the percent delamination for each specimen (averaged across all interfaces). In addition, Table 0 provides the breakdown of the average percent delamination for each interface in the 6-ply specimens.

TABLE M
Adhesive and Surface Treatment for Example 13

| Sample | Adhesive | Surface Treatment |
|---|---|---|
| 1 (7604-240-2B) | LINESTAR ® | none |
| | 4800 adhesive | |
| 2 (7604-240-4B) | LINESTAR ® | 1.5% AIRFLEX ® 426 |
| | 4800 adhesive | |
| 3 (7611-113-10A) | LINESTAR ® | 1% urea |
| | 4800 adhesive | |
| 4 (7604-240-6B) | LINESTAR ® | 1.5% AIRFLEX ® 426 |
| | 4800 adhesive | with 0.125% dodecylbenzene- |
| | | sulfonic acid sodium salt |

TABLE N
Average delamination for each 6-ply billet.

| Sample | % Delamination |
|---|---|
| 1 | 36.5 |
| 2 | 59.6 |
| 3 | 82.5 |
| 4 | 17.9 |

TABLE O
Percent delamination for each interface.

| Sample | Interface 1 | Interface 2 | Interface 3 | Interface 4 | Interface 5 |
|---|---|---|---|---|---|
| 1 | 34.0 | 40.6 | 44.1 | 40.5 | 23.4 |
| 2 | 75.3 | 66.2 | 79.5 | 49.6 | 26.7 |
| 3 | 76.0 | 100 | 67.2 | 73.4 | 95.8 |
| 4 | 40.3 | 5.7 | 15.6 | 0.0 | 27.5 |

The minimum requirements for passing the “Resistance to Delamination During Accelerated Exposure” test are given in Table 2 (section 15) of ASTM Specification D 2559-00. Softwoods like Douglas Fir and Southern Yellow Pine must exhibit less than 5% delamination (overall) with no more than 1% delamination in any bondline.

When comparing the above results to those reported in Example 10, it is apparent that wood surface preparation has a significant effect on bondline integrity. Like SYP (as reported in Example 11), DF laminates provide better resistance to delamination when the surfaces are prepared with sanding instead of planing. Also surprising is the poor performance of urea treated DF. Unlike SYP, urea does not improve the wet delamination resistance of DF laminates. This result corroborates with the dry strength results of Example 7, which similarly show that urea has no effect on the dry strength of planed DF laminates. Thus we see that wood species is an important factor. The above results also show that the AIRFLEX® 426 surface treatment with dodecylbenzene-sulfonic acid sodium salt improves the wet delamination resistance of DF laminates, but the improvement is insufficient to pass the D2559 test. Instead, as shown in Example 11, an unexpected synergistic combination of preparations is required to pass the D2559 test: namely, sanding, and surface treatment, where AIRFLEX® 426 surface treatment with a surfactant is an example of an adequate treatment.

### Example 14

The wood for this example included planed Southern Yellow Pine. Sample preparation methods, wood conditioning criteria, and block shear testing methods were identical to those described in Example 2 (these methods were similar to those described in ASTM D2559-00).

The methods used for lamination were also the same as those given in Example 2, where six samples were pressed at one time for subsequent averaging of results. In each case, 0.3 g of the adhesive was applied to one surface of a single block taken from each pair of block assemblies using a 1″ soft nylon bristle brush as previously described. All samples were allowed to condition for at least 18 hours prior to lamination in the aforementioned humidity control chamber (45% relative humidity, 38° C.; final wood moisture content of 8-9%). The resultant shear strength values (force to failure) were averaged and converted to pounds per square inch (psi) by accounting for the surface area at the adhered interface (3.5 square inches). In addition, the average percentage of visual wood failure was reported for each group. Table P provides the materials that were used for this example, while Table Q provides the results of block shear tests for each group.

The adhesives in this example include LINESTAR® 4605 adhesive, and LINESTAR® 4605 adhesive modified with CAPA® 6501 polycaprolactone (via procedures as outlined in example 9). As discussed in example 9, the polycaprolactone-modified adhesives have the characteristics of being heterogeneous, high viscosity, semi-solid gels at room temperature; whereas at temperatures above about 60° C., the adhesives are homogeneous molten liquids. Both “states” of the polycaprolactone-modified adhesives were used to prepare block shear samples for this example.

TABLE P
Adhesives (including the state of each) and Surface
treatments for Example 14 Samples.

| | | Wood | Surface |
|---|---|---|---|
| Sample | Adhesive | Type | Treatment |
| 1 (83-1) | LINESTAR ® 4605 adhesive | SYP | none |
| 2 (92-5) | LINESTAR ® 4605 adhesive | SYP | none |
| | with 4.76% CAPA ® | | |
| | 6501 product (semi-solid) | | |
| 3 (92-3) | LINESTAR ® 4605 | SYP | none |
| | adhesive with 9.09% CAPA ® | | |
| | 6501 product (semi-solid) | | |
| 4 (92-6) | LINESTAR ® 4605 | SYP | none |
| | adhesive with 4.76% CAPA ® | | |
| | 6501 product (liquid) | | |
| 5 (92-1) | LINESTAR ® 4605 | SYP | none |
| | adhesive with 9.09% CAPA ® | | |
| | 6501 product (liquid) | | |
| 6 (143-1) | LINESTAR ® 4605 adhesive with | SYP | none |
| | 16.67% CAPA ® 6501 | | |
| | product (semi-solid) | | |
| 7 (143-9) | LINESTAR ® 4605 adhesive with | SYP | 1.0% Z6020P |
| | 16.67% CAPA ® 6501 product | | |
| | (semi-solid) | | |

TABLE Q
Average Block Shear Strengths (psi) and Percentage
of Wood Failure for Example 14 Samples.

| Sample | Shear Strength (psi) | % Wood Failure |
|---|---|---|
| 1 | 1200 | 60 |
| 2 | 1690 | 85 |
| 3 | 1830 | 95 |
| 4 | 1570 | 90 |
| 5 | 1740 | 95 |
| 6 | 1800 | 90 |
| 7 | 1600 | 100 |

The minimum requirements for passing the “Resistance to Shear by Compression Loading” are given in Table 1 of ASTM D2559-00. Southern Yellow Pine with 8% moisture contents must have minimum strength requirements of 1440 psi. In addition, the percentage of wood failure must be not less than 75% (per section 14.4.2). Based on the results provided above, several types of samples pass both requirements of the test with or without surface treatment. The performance is particularly improved when the adhesives are comprised of a high molecular weight crystalline component as exemplified by the use of high molecular weight polycaprolactone. Furthermore, when defect-free and gap-free samples are cured under pressure (such as the samples in this example), the dry-strength performance is satisfactory—independent of whether the polycaprolactone-modified adhesives are applied as molten liquids, or as semi-solid, heterogeneous gels. However, the semi-solid state of the adhesive is particularly advantageous in applications where there are gaps (either by design as in I-joists, or by error as in random defects) since the structural integrity of the adhesive is greater when it is applied and cured from its semi-solid state.

### Example 15

This example illustrates the strength improvement that is achieved in the presence of gaps when polycaprolactone is incorporated into the isocyanate adhesive. Samples for this example were prepared via procedures similar to those described in ASTM D 3931-93a entitled “Standard Test Method for Determining Strength of Gap-Filling Adhesive Bonds in Shear by Compression Loading.” This procedure is fully incorporated herein by reference.

The wood in this example was planed SYP. The wood was pre-cut into 2″×4″×¾ blocks with the grain running parallel to the 2″ sides. The blocks were matched into pairs and were conditioned for 24 hours at 38° C., 45% RH. The blocks were removed from the humidity cabinet, and each 2″×4″ surface was treated with a 1% solution of urea in water. After approximately 1 hour (the urea solution was dry to the touch), masking tape was used to secure 0.060″ wood spacers along the 2″ sides of a single block from each pair such that a “gap” of approximately 3″×2″×0.060″ remained in the center section. The blocks were then allowed to recondition for an additional 24 hours. After conditioning, each type of adhesive was applied at a level sufficient so as to over-fill the gaps of 6 replicate samples, where again the gaps were created by the 0.060″ spacers. A matching block from each pair was then placed over the block containing the spacers and adhesive; and the excess adhesive was squeezed out of the resulting laminate such that a sufficient amount remained to fill the gap between the block pairs. The pairs were oriented such that the treated surfaces were in contact with the adhesive over a 3″×1¾″ contact area. This allowed ¼″ of each block to overhang in a “lap-shear” type geometry as described in Example 1. Assembly time for the six replicates was limited to approximately 5 minutes. The six replicates were placed onto a 12″×12″ aluminum plate, and a second 12″×12″ plate (weighing approximately 20 pounds) was placed on top of the entire set (equating to a pressure of approximately 0.48 psi). The entire assembly was then placed into a humidity cabinet at 38° C. and 45% RH for a period of 24 hours to complete the cure. The 2″ edges of the cured blocks (with the spacers) were then trimmed to yield 2″×2″ block shear specimens, similar to those used in prior examples, with the difference being that the center bond-line was comprised of a 0.060″ gap that was filled with cured adhesive.

The gap-filled block shear specimens were tested for shear strength in accordance with procedures outline in Example 2. The adhesives for this example included LINESTAR® 4605 adhesive modified with varying levels of CAPA 6501 product, including 0 phr (parts per hundred resin), 3.5 phr, 7.0 phr, 9.0 phr, 10.5 phr, 12 phr, and 15 phr CAPA 6501 product. In addition, a comparative formulation with 10.5 phr of NICRON 604 talc was prepared to determine the effect of particulate composition on performance.

The polycaprolactone-modified adhesives were prepared via procedures outlined in Example 9. Also as discussed in Example 9, the polycaprolactone-modified adhesives were characterized as being heterogeneous, high viscosity, semi-solid gels at room temperature; whereas at temperatures above about 60° C., the adhesives were homogeneous molten liquids. Both “states” of the polycaprolactone-modified adhesives were used to prepare the gap-filled block shear samples for this example. Also, note that unlike the polycaprolactone-modified adhesives, the comparative formulation with 10.5 phr talc was a liquid at ambient temperatures.

Upon curing, qualitative differences were observed with respect to the degree of foaming within the samples. Samples that were prepared with the semi-solid paste-like adhesives foamed to a much lesser degree than otherwise identical samples that were prepared from the analogous molten adhesives. Also, the degree of foaming in the paste-like samples was observed to decrease at higher concentrations of polycaprolactone. When applied in molten form, the degree of foaming in all of the polycaprolactone modified adhesives was similar to the degree of foaming that was observed in the absence of polycaprolactone. These trends were also mirrored by the qualitative toughness of the materials. Generally, the paste-like adhesives (as applied at room temperature) were more dense and tougher (after cure) than their molten-state counterparts and toughness generally increased with increasing levels of polycaprolactone.

These qualitative observations are quantitatively supported by the shear strengths of the gap-filled samples as reported in the Table R below:

TABLE R
Compressive shear strengths of gap-filled block-shear samples as a
function of additive levels (CAPA ® 6501 polycaprolactone, and
NICRON ® 604 talc), and the state of the adhesive
(liquid vs. semi-solid paste).

| | Shear Strength (psi) | Shear Strength |
|---|---|---|
| | of sample made | (psi) of sample |
| | from semi- | made from |
| Additive | solid state | liquid-state |
| Level (phr) | adhesive | adhesive |
| 0 (neat) | N/A | 89 |
| 3.5 CAPA ® 6501 product | 180 | 60 |
| 7 CAPA ® 6501 product | 683 | 60 |
| 9 CAPA ® 6501 product | 817 | 65 |
| 10.5 CAPA ® 6501 product | 737 | 185 |
| 12 CAPA ® 6501 product | 826 | 205 |
| 15 CAPA ® 6501 product | 983 | 125 |
| 10.5 NICRON ® 604 talc | N/A | 50 |

The strengths of the gap-filled samples increased dramatically as the concentration of polycaprolactone was increased. Also, the strengths of samples prepared from the semi-solid state adhesives were higher than the strengths achieved from the analogous molten liquid-state adhesives. Thus, the gap filling characteristics and the resulting adhesive strengths are surprisingly better when the adhesives are applied from their semi-solid paste-like state. In this way, the degree of foaming is less, and the propensity for the development of stress concentrates (which leads to failure under load) is less. In addition, although not wishing to be bound by any theory, it is believed that the morphology of the adhesive is characterized as having crystalline domains which can serve to reinforce and strengthen the adhesive, whereas when the adhesive is applied from the molten state, the chemical cross linking reaction occurs before an effective (performance enhancing) degree of re-crystallization can occur.

The performance of the comparative sample with 10.5 phr of talc was inferior to that of the sample containing 10.5 phr of polycaprolactone. The talc-containing formulation provided a shear strength of only 50 psi, a value significantly less than the 737 psi value that was achieved with 10.5 phr polycaprolactone (when applied from its paste-like state). Even the comparative molten version of the 10.5 phr polycaprolactone formulation performed better than the formulation containing 10.5 phr of talc. Thus, the unique gap filling features of this invention cannot be achieved by the indiscriminate use of generic fillers or particulates. Instead, a semi-crystalline reinforcing material like polycaprolactone is preferred.

In addition, 0.060″ moisture cured “films” of each adhesive were cast onto plates coated with a TEFLON coating at room temperature for the purpose of determining the effect of the polycaprolactone level on the relative density of the cured adhesives. Each polycaprolactone-modified adhesive was used in its paste-like state, and was drawn down between two 0.060″ wood spacers that were separated by a distance of approximately 3 inches. The films were allowed to set under ambient conditions for a period of two weeks. The adhesive-coated plates were then placed into a humidity cabinet at 45% RH and 38° C. for a period of 1 week to complete the through-cure of the adhesives. The thickness of each cured film was measured and was taken as an indicator of relative density. As can be seen from the results in Table S, the thickness decreases with increasing levels of polycaprolactone. This effect is mirrored by a decrease in the degree of foaming, and by an increase in toughness.

TABLE S
Thickness of one-component polyisocyanate adhesive
films as a function of polycaprolactone level.

| Polycaprolactone | State of | Thickness of cured |
|---|---|---|
| Level (phr) | Adhesive | film (inches) |
| 0 | liquid | 0.200 |
| 3.5 | gel | 0.210 |
| 7 | gel | 0.185 |
| 9 | paste | 0.125 |
| 10.5 | paste | 0.125 |
| 12 | paste | 0.095 |
| 15 | paste | 0.100 |

Again, these results show that the degree of foaming decreases, and, hence, the relative density of the resultant adhesive increases with increasing levels of polycaprolactone. These results also correlate with the increasing strengths that were achieved at higher polycaprolactone levels as reported in Table R. However, the increase in density alone is not the sole reason for the increase in strength. In fact, the sample containing 3.5 phr of polycaprolactone is observed to foam to the same degree as the sample without polycaprolactone (compare the thickness values in Table S), yet the resultant adhesive strength is doubled (see Table R). Thus, the molecular level modification of the adhesive with polycaprolactone has a positive effect on strength. This positive effect is synergistically reinforced by the macroscopic effect of polycaprolactone on both the degree of foaming, and on the resultant density of the cured adhesive.

### Example 16

The wood in this example included both planed and sanded Yellow Poplar. Six plies for each billet (6″×12″× 3/4″) were conditioned at 45% RH, 38° C. for 24 hours to provide a moisture content of 8-9%. For cases involving surface treatments, approximately 5 g of the particular treatment solution was applied to each interface prior to the conditioning period (using a 1″ soft nylon bristle paintbrush).

Approximately 7 g of adhesive was spread at each interface to be bonded (on one surface per interface) using a 4″ wide spatula, and a 1″ soft nylon bristle paint brush. After applying the adhesive, the 6-ply billets were stacked, and were then placed in a Carver Model 2817 hydraulic laboratory press to cure at room temperature at a force adequate to provide a pressure of 250 lbs/in² for sixty (60) minutes. The assembly times ranged from approximately 4 minutes to 5 minutes. The cured billets were allowed to set under ambient conditions for at least 48 hours prior to preparing them for testing.

Testing procedures were the same as those outlined in Example 9. The adhesive for this Example was LINESTAR® 4800 adhesive. The adhesive and surface treatments for the billets are summarized in Table T, while Table U provides a summary of the percent delamination for each specimen (averaged across all interfaces).

TABLE T
Adhesive and Surface Treatment for Example 17

| | Wood | | |
|---|---|---|---|
| Sample | Surface Prep. | Adhesive | Surface Treatment |
| 1 (7604-262-1) | Sanded | LINESTAR ® 4800 adhesive | None |
| 2 (7604-262-2) | Sanded | LINESTAR ® 4800 adhesive | 0.125% |
| | | | dodecylbenzene- |
| | | | sulfonic acid sodium salt |
| 3 (7604-262-3) | Sanded | LINESTAR ® 4800 adhesive | 1% urea |
| 4 (7604-262-4) | Sanded | LINESTAR ® 4800 adhesive | 1.0% AIRFLEX ® 426 |
| | | | with 0.125% |
| | | | dodecylbenzene- |
| | | | sulfonic acid sodium salt |
| 5 (7604-262-5) | Planed | LINESTAR ® 4800 adhesive | None |
| 6 (7604-262-6) | Planed | LINESTAR ® 4800 adhesive | 0.125% |
| | | | dodecylbenzene- |
| | | | sulfonic acid sodium salt |
| 7 (7604-262-7) | Planed | LINESTAR ® 4800 adhesive | 1% urea |
| 8 (7604-262-8) | Planed | LINESTAR ® 4800 adhesive | 1.5% AIRFLEX ® 426 |
| | | | with 0.125% |
| | | | dodecylbenzene- |
| | | | sulfonic acid sodium salt |

TABLE U
Average delamination for the two specimens from each 6-ply billet.

| Sample | % Delamination |
|---|---|
| 1 | 14.0 |
| 2 | 1.6 |
| 3 | 5.5 |
| 4 | 0.5 |
| 5 | 58.5 |
| 6 | 1.2 |
| 7 | 20.3 |
| 8 | 16.7 |

The minimum requirements for passing the “Resistance to Delamination During Accelerated Exposure” test are given in Table 2 (section 15) of ASTM Specification D 2559-00. Softwoods must generally exhibit less than 5% delamination (overall) with no more than 1% delamination in any bondline. The results above show that the LINESTAR® 4800 adhesive can be used to produce Yellow Poplar laminates with the capacity to pass the D2559 wet delamination test (of Section-15).

Like other wood species, the performance of Yellow Poplar is generally better when the wood is sanded and surface treated. However, planed Yellow Poplar also performs surprisingly well with a surface treatment of 0.125% dodecylbenzene-sulfonic acid sodium salt. The results in Table 2 show that surface treatments and/or sanding in combination with surface treatments can be used to improve the performance of Yellow Poplar by a degree sufficient so as to pass the requirements for the “Resistance to Delamination During Accelerated Exposure” test as specified in Table 2 (section 15) of ASTM Specification D 2559-00.

1. A wood adhesive system suitable for preparing lignocellulosic composites that meet all the requirements of either ASTM D-2559-00 Section 14 or ASTM D-2559-00 Sections 14 and 15 comprising:
(a) an organic polyisocyanate composition containing free organically bound isocyanate groups; and
(b) an optional surface treatment.

2. The wood adhesive system according to claim 1, wherein the optional surface treatment comprises an aqueous urea solution.

3. The wood adhesive system according to claim 1, wherein the optional surface treatment comprises an aqueous polyvinyl alcohol solution.

4. The wood adhesive system according to claim 1, wherein the optional surface treatment comprises an aqueous solution of a salt of dodecylbenzene sulfonic acid.

5. The wood adhesive system according to claim 4, wherein the salt of dodecylbenzene sulfonic acid comprises at least one member selected from the group consisting of the sodium salt, the potassium salt, the lithium salt, the ammonium salt, or an organic-amine salt of dodecylbenzene sulfonic acid.

6. The wood adhesive system according to claim 1, wherein the optional surface treatment comprises an aqueous solution of a copolymer of ethylene with vinyl acetate.

7. The wood adhesive system according to claim 6, wherein the copolymer of ethylene with vinyl acetate is a carboxylated poly(ethylene-co-vinyl acetate).

8. The wood adhesive system according to claim 1, wherein the organic polyisocyanate composition comprises an isocyanate functional quasiprepolymer derived from the reaction of: (a) one or more polyols comprising an amine initiated polyether polyol, and (b) a base polyisocyanate consisting essentially of one or more polyisocyanates of the MDI series.

9. The wood adhesive system according to claim 8, wherein the organic polyisocyanate composition further comprises a dispersed crystalline or semicrystalline organic polymer.

10. The wood adhesive system according to claim 9, wherein the dispersed crystalline or semicrystalline organic polymer is formed from a polycaprolactone diol with a number averaged molecular weight greater than 10,000.

11. The wood adhesive system according to claim 9, wherein the dispersed crystalline or semicrystalline organic polymer is formed from a polycaprolactone diol with a number averaged molecular weight greater than 30,000.

12. The wood adhesive system according to claim 9, wherein the dispersed crystalline or semicrystalline organic polymer is formed from a powdered polyethylene.

13. The wood adhesive system according to claim 9, wherein the dispersed crystalline or semicrystalline organic polymer is formed from a combination of a polycaprolactone diol with a number averaged molecular weight greater than 30,000 and a powdered polyethylene.

14. The wood adhesive system according to claim 9, wherein the organic polyisocyanate composition further comprises a soluble inert triglyceride oil.

15. The wood adhesive system according to claim 14, wherein the organic polyisocyanate composition further comprises an inorganic filler comprising a mixture of talc and calcium oxide.

16. A wood adhesive suitable for preparing lignocellulosic composites comprising:
(a) an isocyanate functional quasiprepolymer derived from the reaction of: (i) one or more polyols comprising an amine initiated polyether polyol, and (ii) a base polyisocyanate consisting essentially of one or more polyisocyanates of the MDI series;
(b) a dispersed crystalline or semicrystalline organic polymer;
(c) a soluble inert triglyceride oil; and
(d) an inorganic filler comprising a mixture of talc and calcium oxide.

17. The wood adhesive according to claim 16, wherein the dispersed crystalline or semicrystalline organic polymer comprises at least one member selected from the group consisting of surface oxidized crystalline or semicrystalline polyethylene powders and hydroxy terminated crystalline or semicrystalline polycaprolactones with a number averaged molecular weight greater than 10,000.

18. The wood adhesive according to claim 16, wherein the dispersed crystalline or semicrystalline organic polymer comprises an isocyanate terminated reaction product of a polycaprolactone diol having a number averaged molecular weight of greater than 30,000.

19. A wood adhesive system suitable for preparing lignocellulosic composites that meet all the requirements of either ASTM D-2559-00 Section 14 or ASTM D-2559-00 Sections 14 and 15 comprising:
(a) an isocyanate functional quasiprepolymer derived from the reaction of: (i) one or more polyols comprising an amine initiated polyether polyol, and (ii) a base polyisocyanate consisting essentially of one or more polyisocyanates of the MDI series; and
(b) an optional surface treatment.

20. The wood adhesive system according to claim 19, wherein the optional surface treatment comprises an aqueous urea solution.

21. The wood adhesive system according to claim 19, wherein the optional surface treatment comprises an aqueous polyvinyl alcohol solution.

22. The wood adhesive system according to claim 19, wherein the optional surface treatment comprises an aqueous solution of a salt of dodecylbenzene sulfonic acid.

23. A process for preparing a lignocellulosic bonded article that satisfies the requirements of either Section 14 of ADTM D-2559-00 or Sections 14 and 15 of ASTM D-2559-00 comprising the steps of:
(a) providing at least two lignocellulosic surfaces;
(b) providing an adhesive system comprising:
(i) an organic polyisocyanate composition containing free organically bound isocyanate groups; and
(ii) an optional surface treatment;
(c) applying the adhesive system to at least a portion of at least one of the lignocellulosic surfaces; and
(d) contacting the at least one lignocellulosic surface with another lignocellulosic surface under conditions suitable for forming an adhesive bond between the surfaces.

24. The process according to claim 23, wherein the optional surface treatment is selected from the group consisting of aqueous urea solution, aqueous polyvinyl alcohol solution, and aqueous solution of a copolymer of ethylene with vinyl acetate.

25. The process according to claim 23, wherein the organic polyisocyanate composition comprises an isocyanate functional quasiprepolymer derived from the reaction of: (a) one or more polyols comprising an amine initiated polyether polyol, and (b) a base polyisocyanate consisting essentially of one or more polyisocyanates of the MDI series.

26. The process according to claim 25, wherein the organic polyisocyanate composition further comprises a dispersed crystalline or semicrystalline organic polymer.

27. The process according to claim 26, wherein the organic polyisocyanate composition further comprises a soluble inert triglyceride oil.

28. The process according to claim 27, wherein the organic polyisocyanate composition further comprises an inorganic filler comprising a mixture of talc and calcium oxide.

29. An adhesive bonded lignocellulosic article that meet all the requirements of either ASTM D-2559-00 Section 14 or ASTM D-2559-00 Sections 14 and 15 that is prepared using a wood adhesive comprising:
(a) an isocyanate functional quasiprepolymer derived from the reaction of: (i) one or more polyols comprising an amine initiated polyether polyol, and (ii) a base polyisocyanate consisting essentially of one or more polyisocyanates of the MDI series;
(b) a dispersed crystalline or semicrystalline organic polymer;
(c) a soluble inert triglyceride oil; and
(d) an inorganic filler comprising a mixture of talc and calcium oxide.

30. An adhesive bonded lignocellulosic article that meet all the requirements of either ASTM D-2559-00 Section 14 or ASTM D-2559-00 Sections 14 and 15 that is prepared using a wood adhesive comprising:
(a) an isocyanate functional quasiprepolymer derived from the reaction of: (i) one or more polyols comprising an amine initiated polyether polyol, and (ii) a base polyisocyanate consisting essentially of one or more polyisocyanates of the MDI series; and
(b) an optional surface treatment.

31. The adhesive bonded lignocellulosic article of claim 30, wherein the optional surface treatment is selected from the group consisting of aqueous urea solution, aqueous polyvinyl alcohol solution, and aqueous solution of a copolymer of ethylene with vinyl acetate.
